(19) United States
(12) Patent Application Publication
(10) Pub. No.: US 2026/0114438 A1
(43) Pub. Date: Apr. 30, 2026

(54) FISHING TACKLE, WATER LANDING LOCATION ESTIMATION SYSTEM, AND FISHING ASSISTANCE SYSTEM

(71) Applicant: Shimano Inc., Sakai (JP)

(72) Inventors: Shu KUSUDA, Sakai (JP); Hirotaka HONDA, Sakai (JP); Kunio TAKECHI, Sakai (JP); Akira NIITSUMA, Sakai (JP); Hiroki OOGOSE, Sakai (JP); Shota MIZUNO, Sakai (JP)

(21) Appl. No.: 19/358,864

(22) Filed: Oct. 15, 2025

(30) Foreign Application Priority Data
Oct. 31, 2024 (JP) 2024-191710

(51) Int. Cl. A01K 97/12

(52) U.S. Cl. CPC A01K 97/125

(57) ABSTRACT

A fishing tackle includes a detection unit that detects an operating state of a fishing tackle in a casting operation, and a calculation unit that estimates the water landing location of the rig that has been cast on the basis of the detection result of the detection unit.

### CROSS-REFERENCE TO RELATED APPLICATIONS

This application claims priority to Japanese Patent Application No. 2024-191710, filed on Oct. 31, 2024.The entire disclosure of Japanese Patent Application No. 2024-191710 is hereby incorporated by reference.

### BACKGROUND

### Technical Field

The present disclosure generally relates to fishing tackle, a water landing location estimation system, and a fishing assistance system.

### Background Information

Conventional devices can be used to detect underwater target objects, such as fish, and to display information on the detection result during actual fishing (for example, refer to Japanese Laid Open Patent Application Nos. 2005-160421 and 2022-147437).

For example, Laid Open Patent Application No. 2005-160421 discloses an information display device and an information display system that, on the basis of information from a fishing reel, displays water depth data D1 of tackles on a display unit that displays detection results.

In addition, in recent years, a detection direction adjustment device and an underwater detection system have been disclosed which can automatically change the detection direction of an underwater exploration device and continue to detect target objects, even if the orientation or position of a ship is changed due to the effects of tides, water currents, waves, wind direction, etc., as in Laid Open Patent Application No. 2022-147437.

### SUMMARY

It has been determined, however, that in conventional devices and systems, the estimated water landing location of a rig that has been cast is unclear, and it is therefore difficult to find a rig that has been cast by an angler within an information display of a detection result, and it is difficult to subsequently track the rig in the water.

The present disclosure was conceived in light of such a circumstance, and an object thereof is to provide fishing tackle, a water landing location estimation system, and a fishing assistance system that can accurately estimate the water landing location of a rig that has been cast.

A first aspect of the present disclosure is a fishing tackle comprising a detection unit that detects an operating state of fishing tackle in a casting operation, and a calculation unit that estimates the water landing location of the rig that has been cast on the basis of the detection result of the detection unit.

According to the configuration described above, as a result of the fishing tackle being equipped with a detection unit that detects the operating state of the fishing tackle in a casting operation, the water landing location of the rig that has been cast can be estimated on the basis of the detection result of the operating status of the casting operation, so that the water landing location can be accurately estimated.

A second aspect of the present disclosure is the fishing tackle according to the first aspect, wherein the detection unit can be provided on at least one of a fishing rod, a fishing reel attached to the fishing rod, a fishing line wound around the fishing reel or released from the fishing reel, and a rig attached to the fishing line.

According to the configuration described above, the water landing location of the rig that has been cast is estimated on the basis of the operating state of at least one of a fishing rod, a fishing reel, a fishing line, and a rig, so that a more accurate estimation is possible.

A third aspect of the present disclosure is the fishing tackle according to the first or the second aspects, wherein a plurality of the detectors can be provided on a fishing rod, a fishing reel attached to the fishing rod, a fishing line wound around the fishing reel or released from the fishing reel, or a rig attached to the fishing line, and the calculation unit can estimate the water landing location of the rig that has been cast on the basis of the detection results of the plurality of detectors.

According to the configuration described above, the water landing location of the rig that has been cast is estimated on the basis of the operating states of a plurality of items among a fishing rod, a fishing reel, a fishing line, or a rig, so that more an accurate estimation is possible.

A fourth aspect of the present disclosure is the fishing tackle according to any one of the first to the third aspects, wherein the calculation unit can be provided on at least one of a fishing rod, a fishing reel attached to the fishing rod, a fishing line wound around the fishing reel or released from the fishing reel, and a rig attached to the fishing line.

According to the configuration described above, the calculation unit is provided on at least one of a fishing rod, a fishing reel, a fishing line, and a rig, so that it is not necessary to separately provide a calculation unit, and the casting operation is less likely to be hindered.

A fifth aspect of the present disclosure is the fishing tackle according to any one of the first to the fourth aspects, wherein the fishing tackle can further comprise a display unit that displays a predicted water landing location of the rig estimated by the calculation unit.

According to the configuration described above, an angler, etc., can visually ascertain the predicted water landing location of the rig.

A sixth aspect of the present disclosure is a water landing location estimation system comprising fishing tackle that can cast fishing tackle and that has a detection unit that detects an operating state of a fishing tackle in a casting operation, and a calculation unit that estimates the water landing location of the rig that has been cast on the basis of the detection result of the detection unit.

According to the configuration described above, as a result of the fishing tackle being equipped with a detection unit that detects the operating state of a fishing tackle in a casting operation, the water landing location of the rig that has been cast can be estimated on the basis of the detection result of the operating status of the casting operation, so that the water landing location can be accurately estimated.

A seventh aspect of the present disclosure is the water landing location estimation system according to the sixth aspect, wherein the detection unit has at least one of: a direction detection section that detects the direction of motion of the fishing tackle in the casting operation of the rig; an acceleration detection section that detects the acceleration applied to the fishing tackle in the casting operation of the rig; a speed detection section that detects the speed of the fishing tackle in the casting operation of the rig; an angular velocity detection section that detects the angular velocity of the fishing tackle in the casting operation of the rig; a position detection section that detects the position of the fishing tackle in the casting operation of the rig; and a bending detection section that detects the bending moment acting on the fishing tackle in the casting operation of the rig.

According to the configuration described above, the water landing location of the rig that has been cast can be accurately estimated on the basis of at least one of the direction of motion of the fishing tackle in the casting operation of the rig, the acceleration applied to the fishing tackle in the casting operation of the rig, the speed of the fishing tackle in the casting operation of the rig, the angular velocity of the fishing tackle in the casting operation of the rig, the position of the fishing tackle in the casting operation of the rig, and the bending moment acting on the fishing tackle in the casting operation of the rig.

An eighth aspect of the present disclosure is the water landing location estimation system according to the sixth or the seventh aspects, wherein the detection unit has a plurality of elements among a direction detection section that detects the direction of motion of the fishing tackle in the casting operation of the rig; an acceleration detection section that detects the acceleration applied to the fishing tackle in the casting operation of the rig; a speed detection section that detects the speed of the fishing tackle in the casting operation of the rig; an angular velocity detection section that detects the angular velocity of the fishing tackle in the casting operation of the rig; a position detection section that detects the position of the fishing tackle in the casting operation of the rig; and a bending detection section that detects the bending moment acting on the fishing tackle in the casting operation of the rig, and the calculation unit can estimate the water landing location of the rig that has been cast on the basis of the detection results of the plurality of detection sections.

According to the configuration described above, the water landing location of the rig that has been cast can be accurately estimated on the basis of a plurality of criteria among the direction of motion of the fishing tackle in the casting operation of the rig, the acceleration applied to the fishing tackle in the casting operation of the rig, the speed of the fishing tackle in the casting operation of the rig, the angular velocity of the fishing tackle in the casting operation of the rig, the position of the fishing tackle in the casting operation of the rig, and the bending moment acting on the fishing tackle in the casting operation of the rig.

A ninth aspect of the present disclosure is the water landing location estimation system according to any one of the sixth to the eighth aspects, wherein: the fishing tackle includes a fishing rod, the detection unit has a rod detection unit that is provided on the fishing rod and detects the operating status of the fishing rod in the casting operation of the rig, and the rod detection unit can include at least one of: a rod tip direction detection section that detects the direction of the rod tip of the fishing rod in the casting operation of the rig; a rod acceleration detection section that detects the acceleration of the fishing rod in the casting operation of the rig; a rod speed detection section that detects the speed of the fishing rod in the casting operation of the rig; a rod angular velocity detection section that detects the angular velocity of the fishing rod in the casting operation of the rig; a rod position detection section that detects the position of the fishing rod in the casting operation of the rig; and a rod bending detection section that detects the bending moment acting on the fishing rod in the casting operation of the rig.

The configuration described above includes a rod detection unit that detects the operating status of the fishing rod in the casting operation of the rig, and the water landing location of the rig that has been cast can be accurately estimated on the basis of at least one of the direction of the rod tip of the fishing rod in the casting operation of the rig, the acceleration of the fishing rod in the casting operation of the rig, the speed of the fishing rod in the casting operation of the rig, the angular velocity of the fishing rod in the casting operation of the rig, the position of the fishing rod in the casting operation of the rig, and the bending moment acting on the fishing rod in the casting operation of the rig.

A tenth aspect of the present disclosure is a water landing location estimation system according to any one of the sixth to the ninth aspects, wherein the fishing tackle includes a fishing reel, the detection unit includes a reel detection unit that is provided on the fishing reel and detects the operating status of the fishing reel in the casting operation of the rig, and the reel detection unit includes a reel direction detection section that detects the direction of the fishing reel in the casting operation of the rig and/or a reel acceleration detection section that detects the acceleration applied to the fishing reel in the casting operation of the rig

The configuration described above includes a reel detection unit that detects the operating status of the fishing reel in the casting operation of the rig, and the water landing location of the rig that has been cast can be accurately estimated on the basis of the direction of the fishing reel in the casting operation of the rig and/or the acceleration applied to the fishing reel in the casting operation of the rig.

An eleventh aspect of the present disclosure is a water landing location estimation system according to any one of the sixth to the tenth aspects, wherein the fishing tackle includes a fishing reel provided with a spool around which a fishing line is wound, the detection unit includes a spool detection unit that is provided on the fishing reel and detects operation of the spool in the casting operation of the rig, and the spool detection unit can include at least one of: a line release length detection section that detects the length of the fishing line released from the spool in the casting operation of the rig; a line release acceleration detection section that detects the acceleration of the fishing line released from the spool in the casting operation of the rig; and a line release speed detection section that detects the speed of the fishing line released from the spool in the casting operation of the rig.

The configuration described above includes a spool detection unit that detects the operation of the spool in the casting operation of the rig, and the water landing location of the rig that has been cast can be accurately estimated on the basis of at least one of the length of the fishing line released from the spool in the casting operation of the rig, the acceleration of the fishing line released from the spool in the casting operation of the rig, and the speed of the fishing line released from the spool in the casting operation of the rig.

The twelfth aspect of the present disclosure is a water landing location estimation system according to any one of the sixth to the eleventh aspects, wherein: the fishing tackle includes a fishing rod and a fishing reel that is attached to the fishing rod and is provided with a spool around which a fishing line is wound; the detection unit includes a plurality of items among a rod detection unit that is provided on the fishing rod and detects the operating status of the fishing rod in the casting operation of the rig, a reel detection unit that is provided on the fishing reel and detects the operating status of the fishing reel in the casting operation of the rig, and a spool detection unit that is provided on the fishing reel and detects the operation of the spool in the casting operation of the rig; and the calculation unit can estimate the water landing location of the rig that has been cast on the basis of the detection results of the plurality of detection sections.

According to the configuration described above, the water landing location of the rig that has been cast can be accurately estimated on the basis of a plurality of criteria among the operating status of the fishing rod in the casting operation of the rig, the operating status of the fishing reel in the casting operation of the rig, and the operation of the spool in the casting operation of the rig.

A thirteenth aspect of the present disclosure is the water landing location estimation system according to any one of the sixth to the twelfth aspects, wherein the system can further comprise a display unit that displays the predicted water landing location of the rig estimated by the calculation unit.

According to the configuration described above, an angler, etc., can visually ascertain the predicted water landing location of the rig.

The fourteenth aspect of the present disclosure is a fishing assistance system comprising a detection unit that detects an operating state of a fishing tackle in a casting operation, a calculation unit that estimates the water landing location of the rig that has been cast on the basis of the detection result of the detection unit, an underwater detection unit that detects an underwater target object, and a control unit that controls the underwater detection unit on the basis of the calculation result of the calculation unit.

According to the configuration described above, as a result of the fishing tackle being equipped with a detection unit that detects the operating state of a fishing tackle in a casting operation, the water landing location of the rig that has been cast can be accurately estimated, thereby assisting fishing.

A fifteenth aspect of the present disclosure is the fishing assistance system according to the fourteenth aspect, wherein the control unit can control the detection direction of the underwater detection unit on the basis of the calculation result of the calculation unit.

According to the configuration described above, the detection direction in which an underwater target object is detected can be appropriately controlled in accordance with the water landing location of the rig that has been cast.

The sixteenth aspect of the present disclosure is the fishing assistance system according to the fourteenth or the fifteenth aspects, wherein the control unit can control the detection distance of the underwater detection unit on the basis of the calculation result of the calculation unit.

According to the configuration described above, the detection distance at which an underwater target object is detected can be appropriately controlled in accordance with the water landing location of the rig that has been cast.

A seventh aspect of the present disclosure is the fishing assistance system according to any one of the fourteenth to the sixteenth aspects, wherein the detection unit can be provided on at least one of a fishing rod, a fishing reel attached to the fishing rod, a fishing line wound around the fishing reel or released from the fishing reel, and a tackle attached to the fishing line.

According to the configuration described above, the water landing location of the rig that has been cast can be accurately estimated on the basis of the operating state of at least one of a fishing rod, a fishing reel, a fishing line, and a tackle.

An eighteenth aspect of the present disclosure is the fishing assistance system according to any one of the fourteenth to the seventeenth aspect, wherein a plurality of the detectors are provided on any of a fishing rod, a fishing reel attached to the fishing rod, a fishing line wound around the fishing reel or released from the fishing reel, or a tackle attached to the fishing line, and the calculation unit can estimate the water landing location of the rig that has been cast on the basis of the detection results of the plurality of detectors.

According to the configuration described above, the water landing location of the rig that has been cast can be accurately estimated on the basis of a plurality of operating states of any of a fishing rod, a fishing reel, a fishing line, or a tackle.

A nineteenth aspect of the present disclosure is a fishing assistance system according to any one of the fourteenth to the eighteenth aspects, wherein: the detection unit includes a plurality of items among a rod detection unit that is provided on a fishing rod and detects the operating status of the fishing rod in the casting operation of the rig, a reel detection unit that is provided on the fishing reel and detects the operating status of the fishing reel in the casting operation of the rig, and a spool detection unit that is provided on the fishing reel and detects the operation of the spool in the casting operation of the rig; and the calculation unit can estimate the water landing location of the rig that has been cast on the basis of the detection results of the plurality of detectors.

According to the configuration described above, the water landing location of the rig that has been cast can be accurately estimated on the basis of a plurality of criteria among the operating status of the fishing rod in the casting operation of the rig, the operating status of the fishing reel in the casting operation of the rig, and the operation of the spool in the casting operation of the rig.

A twentieth aspect of the present disclosure is the fishing assistance system according to any one of the fourteenth to the nineteenth aspects, wherein the fishing assistance system can further comprise a display unit that displays a predicted water landing location of the rig estimated by the calculation unit.

According to the configuration described above, an angler, etc., can visually ascertain the predicted water landing location of the rig.

According to the present disclosure, the water landing location of a tackle that has been cast can be accurately estimated by a fishing tackle, a water landing location estimation system, and a fishing assistance system.

### BRIEF DESCRIPTION OF THE DRAWINGS

FIG. 1 is a diagram showing an example configuration of fishing tackle according to an embodiment of the present disclosure.

FIG. 2 is a diagram showing an example configuration of fishing tackle according to an embodiment of the present disclosure, comprising a plurality of detectors.

FIG. 3 is a diagram showing an example configuration of a fishing reel for fishing tackle according to an embodiment of the present disclosure, the fishing reel composed of a spinning reel.

FIG. 4 is a diagram showing another example configuration of a fishing reel for fishing tackle according to an embodiment of the present disclosure, the fishing reel, composed of a dual-bearing reel.

FIG. 5 is a diagram showing an example of a display on a display unit for fishing tackle according to an embodiment of the present disclosure.

FIG. 6 is a diagram showing an example of a display on the display unit for fishing tackle according to an embodiment of the present disclosure.

FIG. 7 is a diagram showing an example configuration of a fishing rod for fishing tackle according to an embodiment of the present disclosure.

FIG. 8 is a diagram showing an example of water landing location prediction based on bending of a fishing rod for fishing tackle according to an embodiment of the present disclosure.

FIG. 9 is a flowchart diagram showing one example of a flow of operation of fishing tackle according to an embodiment of the present disclosure, the fishing reel.

FIG. 10 is a diagram showing an example configuration of a water landing location estimation system according to an embodiment as a water landing location estimation system.

FIG. 11 is a diagram showing an example of a display on a display unit of a terminal device according to an embodiment as a water landing location estimation system.

FIG. 12 is a diagram showing an example configuration of a detection unit according to an embodiment as a water landing location estimation system.

FIG. 13 is a diagram showing an example configuration of a fishing rod including a rod detection unit according to an embodiment as a water landing location estimation system.

FIG. 14 is a diagram showing an example configuration of a fishing reel including a reel detection unit according to an embodiment as a water landing location estimation system.

FIG. 15 is a diagram showing an example configuration of a fishing reel including a spool and a spool detection unit according to an embodiment as a water landing location estimation system.

FIG. 16 is a diagram showing an example configuration of a detection unit including a rod detection unit, a reel detection unit, and a spool detection unit, according to an embodiment as a water landing location estimation system.

FIG. 17 is a diagram showing an example configuration of a water landing location estimation system according to a first modified example of the present disclosure.

FIG. 18 is a diagram showing an example configuration of a water landing location estimation system according to a second modified example of the present disclosure.

FIG. 19 is a diagram showing an example configuration of a fishing assistance system according to an embodiment of the present disclosure.

FIG. 20 is a diagram showing an example of a state in which a tackle is cast in an embodiment as a fishing assistance system.

FIG. 21 is a diagram showing an example of a state in which a tackle is cast in an embodiment as a fishing assistance system.

FIG. 22 is a diagram showing an example of a display on a display unit of an underwater detection device according to an embodiment as a fishing assistance system.

FIG. 23 is a diagram showing an example of a display on a display unit of the underwater detection device according to an embodiment as a fishing assistance system.

FIG. 24 is a flowchart diagram showing one example of a flow of an operation for obtaining and displaying the relationship between the orientation of a fishing rod and the orientation of a bow of a ship according to the embodiment as a fishing assistance system.

FIG. 25 is a flowchart diagram showing one example of a flow of an operation of the fishing assistance system according to an embodiment of the present disclosure.

### DETAILED DESCRIPTION

### Embodiment as Fishing Tackle

### Example Configuration of Fishing Tackle

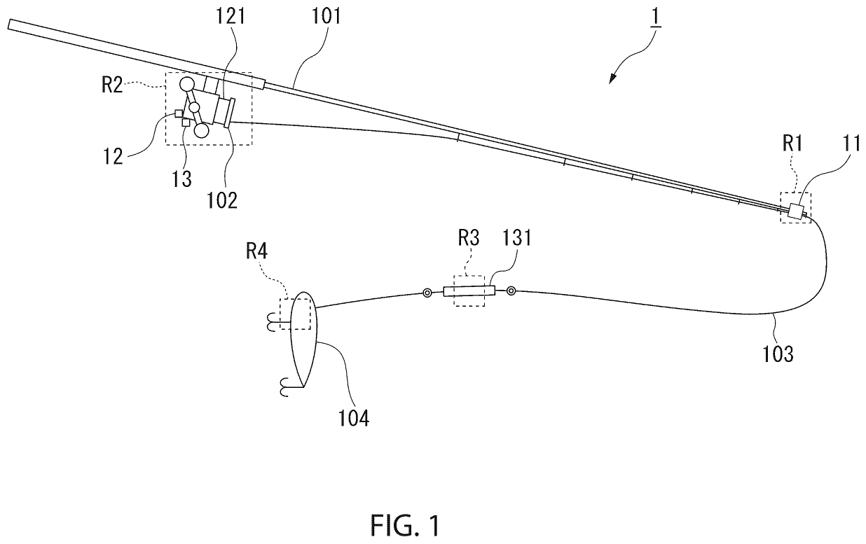

FIG. 1 is a diagram showing an example configuration of a fishing tackle 1 according to an embodiment as fishing tackle. The fishing tackle 1 comprises a fishing rod 101, a fishing reel 102, a fishing line 103, and a rig 104. The fishing tackle 1 also comprises a detection unit (detectors) 11, a calculation unit (calculators) 12, and a display unit 13.

In the example shown in FIG. 1, the detection unit 11 is provided on the fishing rod 101, and the calculation unit 12 and the display unit 13 are provided on the fishing reel 102. Here, in the present embodiment, an example is shown in which the fishing tackle 1 comprises the display unit 13, but as another example, the fishing tackle 1 need not comprise the display unit 13.

The detection unit 11 detects the operating state of the fishing tackle 1 in a casting operation. The calculation unit 12 estimates the water landing location of the rig 104 that has been cast on the basis of the detection result of the detection unit 11. Various methods can be used to estimate the water landing location on the basis of the detection result, such as a method in which calculation is carried out by a preset calculation formula, etc., using the detection result as a parameter to determine the water landing location.

The display unit 13 displays the predicted water landing location of the rig 104 estimated by the calculation unit 12. The predicted water landing location is, for example, a water landing location estimated by the calculation unit 12, but, as another example, can be a position obtained by correcting the water landing location using a preset correction calculation formula, etc.

Here, the detection unit 11, the calculation unit 12, and the display unit 13 can be respectively composed of any piece of hardware. For example, the detection unit 11 is composed of a sensor that detects a physical quantity of a detection target. Various sensors can be used as the sensor. For example, the calculation unit 12 can be composed of a computer such as a microcontroller (so-called microcomputer).

The display unit 13 can be composed of a display such as a liquid crystal display having a display screen. In addition, in the present embodiment, the detection unit 11 and the calculation unit 12 can communicate with each other, and the calculation unit 12 and the display unit 13 can communicate with each other.

The communications can be, for example, wireless communication or wired communication. For example, short-range wireless communication such as Blue Tooth Low Energy (BLE) can be used as the wireless communication.

The fishing reel 102 includes a spool 121. The fishing reel 102 is attached to the fishing rod 101. The fishing line 103 is wound around the fishing reel 102 or released from the fishing reel 102.

In the present example, the fishing line 103 includes a connector 131 midway along the line. The connector 131 is flexible, for example, and a line is respectively connected the two ends thereof. In the present example, the connector 131 is a component of the fishing line 103.

The rig 104 is attached to the fishing line 103. Here, the direction of the fishing rod 101 in which the fishing line 103 extends from the fishing reel 102 and in which the rig 104 is attached is defined as the rod tip. The configuration of the fishing tackle 1 is not particularly limited, and various configurations can be used.

### Arrangement of the Detection Unit

Without being limited to the example shown in FIG. 1, the detection unit 11 is provided on at least one of the fishing rod 101, the fishing reel 102, the fishing line 103, and the rig 104.

FIG. 1 schematically shows a prescribed region R1 of the fishing rod 101, a prescribed region R2 of the fishing reel 102, a prescribed region R3 of the fishing line 103, and a prescribed region R4 of the rig 104. In the present example, the region R3 of the fishing line 103 is shown to be at the location of the connector 131, but the region R3 can be elsewhere. In the present embodiment, the detection unit 11 can be provided in at least one of the plurality of regions R1-R4.

With respect to the position where the detection unit 11 is provided, the placement of the prescribed region R1 of the fishing rod 101, the placement of the prescribed region R2 of the fishing reel 102, the placement of the prescribed region R3 of the fishing line 103, and the placement of the prescribed region R4 of the rig 104 are not necessarily limited to the example shown in FIG. 1.

### Placement of Calculation Unit

Without being limited to the example shown in FIG. 1, the calculation unit 12 is provided on at least one of the fishing rod 101, the fishing reel 102, the fishing line 103, and the rig 104. In the present embodiment, the calculation unit 12 can be provided in at least one of the plurality of regions R1-R4 shown in FIG. 1.

With respect to the position where the calculation unit 12 is provided, the placement of the prescribed region R1 of the fishing rod 101, the placement of the prescribed region R2 of the fishing reel 102, the placement of the prescribed region R3 of the fishing line 103, and the placement of the prescribed region R4 of the rig 104 are not necessarily limited to the example shown in FIG. 1.

For example, two or all of the detection unit 11, the calculation unit 12, and the display unit 13 can be provided in adjacent positions, or the detection unit 11, the calculation unit 12, and the display unit 13 can be respectively provided in different (non-adjacent) positions.

### Example Configuration of a Fishing Tackle Comprising a Plurality of Detectors

A plurality of the detectors 11 can be provided in the fishing tackle 1. In this case, the plurality of the detectors 11 are provided on any one of the fishing rod 101, the fishing reel 102, the fishing line 103, and the rig 104.

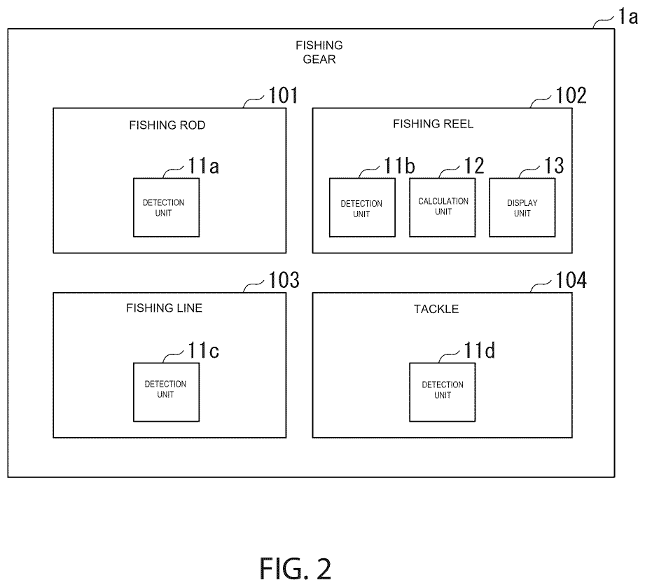

The calculation unit 12 estimates the water landing location of the rig 104 that has been cast on the basis of the detection results of the plurality of detectors 11. FIG. 2 is a diagram showing an example configuration of fishing tackle 1a comprising a plurality of detectors (rod detector 11a, reel detector 11b, line detector 11c, the rig detector 11d) according to the embodiment as fishing tackle.

Here, the fishing tackle 1a is one example configuration of the fishing tackle 1 shown in FIG. 1. In the present example, the detection unit 11 includes four detectors, the rod detector 11a provided on the fishing rod, the reel detector 11b provided in the fishing reel, the line detector 11c provided on the fishing line, and the rig detector 11d attached to the rig. These four detectors (rod detector 11a, reel detector 11b, line detector 11c, the rig detector 11d) can detect the same physical quantity (for example, acceleration or speed), or can detect different physical quantities.

As another example configuration, the detection unit 11 can have any two or three detectors from among these four detectors (rod detector 11a, reel detector 11b, line detector 11c, the rig detector 11d).

In the fishing tackle 1a according to the embodiment as fishing tackle, the rod detector 11a is provided on the fishing rod 101, the reel detector 11b is provided in the fishing reel 102, the line detector 11c is provided on the fishing line 103, and the rig detector 11d is provided on the rig 104.

In addition, in the fishing tackle 1a, the fishing reel 102 is provided with the calculation unit 12 and the display unit 13. As another example configuration, the calculation unit 12 and the display unit 13 can be respectively provided at locations other than the fishing reel 102.

### Example Configuration of Fishing Reel

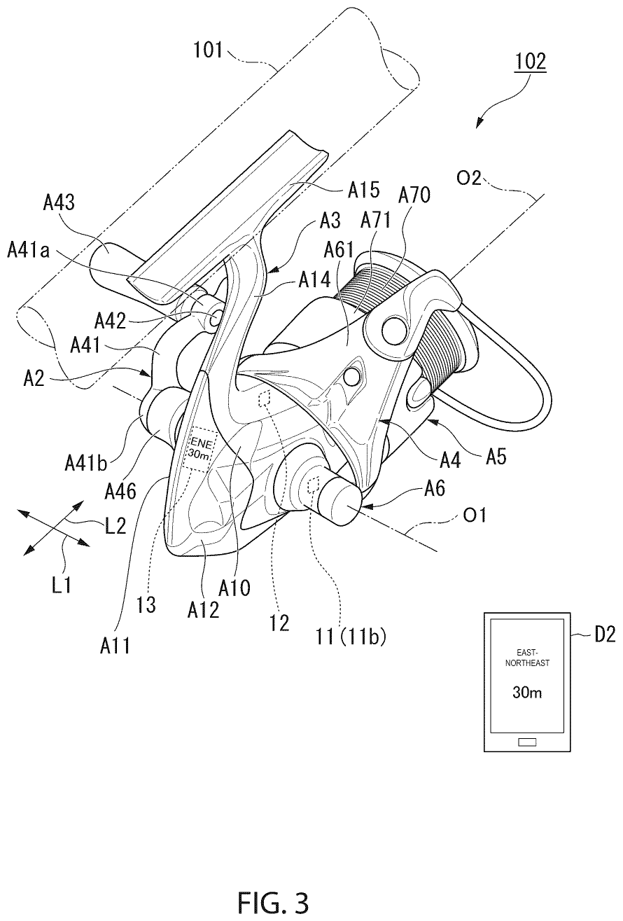

FIG. 3 is a diagram showing an example configuration of a fishing reel 102 composed of a spinning reel according to the embodiment as fishing tackle. FIG. 3 also shows the fishing rod 101. In the present example, the fishing reel 102 comprises the detection unit 11 (reel detector 11b), the calculation unit 12, and the display unit 13. The display unit 13 displays the information “ENE 30m” as one example of a display. This means a distance of 30 m in the east-northeast direction.

FIG. 3 also illustrates a terminal device D2 displaying, on the screen, the information “east-northeast 30 m.” In this case, the information is transmitted from the calculation unit 12 of the fishing reel 102 to the terminal device D2.

For example, the detection unit 11 (reel detector 11b) can be a sensor that detects the direction of the fishing reel 102 (direction of a spool axis O2 of the fishing reel 102) or the acceleration that is applied to the fishing reel 102 when casting. The fishing reel 102 has a handle assembly A2 that can be rotated around a handle axis O1, and mainly comprises a reel body A3 that can be mounted on the fishing rod 101, a rotor A4 that is combined with the reel body A3 so as to be rotatable around the spool axis O2, a spool A5 that is combined with the reel body A3 so as to be movable in reciprocating fashion along the spool axis O2 and around which fishing line (not shown) is wound, and a sensor unit A6 that is detachably attached to the reel body A3.

The handle axis O1 and the spool axis O2 intersect so as to be essentially orthogonal to each other. In the present embodiment, a direction along the handle axis O1 is defined as the left-right direction L1 and the direction along the spool axis O2 is defined as the front-rear direction L2. In addition, the direction in which the fishing line is unreeled from the spool A5 in the front-rear direction L2 is defined as forward, the opposite direction is defined as rearward, and left and right are defined according to a rear view of the fishing reel 102 (that is, as seen from the viewpoint of the user, who is not shown).

Furthermore, the direction that intersects the handle axis O1 as seen from the handle axis O1 direction can be referred to as the radial direction, and the direction encircling the handle axis O1 can be referred to as the circumferential direction. Furthermore, the radial direction from the handle axis O1 to the fishing rod 101 is referred to as upward, and the opposite direction is referred to as downward.

The reel body A3 includes a body frame part A10, a lid part A11 (the approximate location is shown, while a detailed illustration is omitted), and a guard member A12.

A leg portion A14 is integrally formed at the upper portion of the body frame part A10 so as to extend upward. A mounting piece A15 to be attached to the fishing rod 101 is formed at the upper end portion of the leg portion A14 so as to extend along the fishing rod 101.

The fishing rod 101 shown in FIG. 3 is schematically illustrated, and illustrations of components that are commonly provided on the fishing rod 101, such as a reel mounting base (reel seat), are omitted.

The guard member A12 is a cover part that covers the rear portion of the body frame part A10 and the rear portion of the lid part A11 from the rear side. However, the guard member A12 is not an essential component, and thus need not be provided. The guard member A12 is detachably fixed to the rear portion of the body frame part A10 with a fixing bolt, which is not shown.

The handle assembly A2 and the sensor unit A6 are attached to the reel body A3 using a first handle mounting portion and a second handle mounting portion. Specifically, the sensor unit A6 is attached to the right side of the reel body A3 using the first handle mounting portion, and the handle assembly 2 is attached to the left side of the reel body 3 using the second handle mounting portion.

In the present example, the fishing reel 102 is an example of a left handle reel. However, the disclosure is not limited to this case; the spinning reel can be switched to right-handle mode by attaching the handle assembly using the first handle mounting portion and attaching the sensor unit using the second handle mounting portion.

The spool A5 comprises a bobbin trunk A70 around which the fishing line is wound, and a cylindrical skirt portion A71 that is formed extending rearward from the rear-end portion of the bobbin trunk A70 and to surround the rotor A4 from the outer side in the radial direction, and is disposed forward of the rotor A4, coaxially with the spool axis O2. The spool A5 is configured to be capable of moving in reciprocating fashion along the spool axis O2 with respect to the reel body A3.

As described above, the sensor unit A6 is detachably attached to the reel body A3. In addition, the sensor unit A6 is attached to the right side (on the opposite side of the handle assembly A2 with respect to the reel body A3) on the axis of the handle shaft using the first handle mounting portion. The sensor unit A6 includes the detection unit 11 (reel detector 11b) that detects the operating status of the fishing reel 102 in the casting operation of the rig 104.

In addition, as will be described further below, the detection unit 11 includes at least one of a reel direction detection section 471 that detects the direction of the fishing reel 102 in the casting operation of the rig 104 and/or a reel acceleration detection section 472 that detects the acceleration applied to the fishing reel 102 in the casting operation of the rig 104.

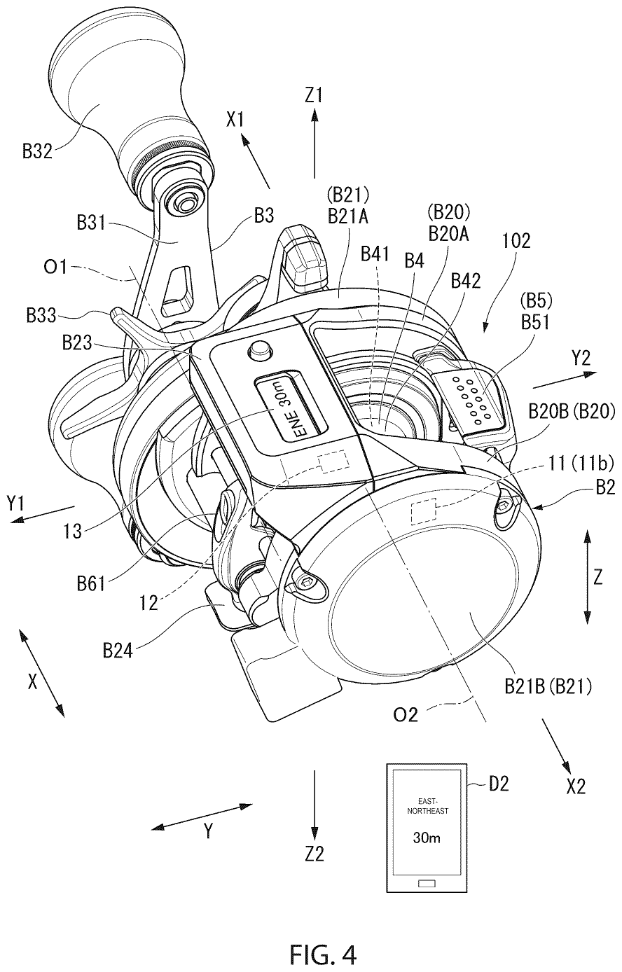

Here, the reel direction detection section 471 and the reel acceleration detection section 472 are the same as those shown in FIG. 14. FIG. 4 is a diagram showing another example configuration of the fishing reel 102 composed of a dual-bearing reel according to the embodiment as fishing tackle. In the present example, the fishing reel 102 comprises the detection unit 11 (reel detector 11b), the calculation unit 12, and the display unit 13. The display unit 13 displays the information “ENE 30 m” as one example of a display. This means a distance of 30 m in the east-northeast direction.

FIG. 4 also illustrates a terminal device D2 displaying, on the screen, the information “east-northeast 30 m.” In this case, the information is transmitted from the calculation unit 12 of the fishing reel 102 to the terminal device D2. For example, the detection unit 11 (reel detector 11b) is provided on a left-side wall B20B of the reel body B2, which is the opposite side (palming side) of a handle B3, and is covered by a left side cover B21B that covers a left-side wall B20B.

The detection unit 11 has a spool detection unit 511 that detects the operation of a spool B4 in the casting operation of the rig 104. In addition to the reel direction detection section 471 that detects the direction of the fishing reel 102 in the casting operation of the rig 104 and the reel acceleration detection section 472 that detects the acceleration applied to the fishing reel 102 in the casting operation of the rig 104 in the embodiment as fishing tackle, the spool detection unit 511 includes at least one of: a line release length detection section 531 that detects the length of a fishing line 103 released from the spool B4 in the casting operation of the rig 104; a line release acceleration detection section 532 that detects the acceleration of the fishing line 103 released from the spool B4 in the casting operation of the rig 104; and a line release speed detection section 533 that detects of the speed of the fishing line 103 released from the spool B4 in the casting operation of the rig 104.

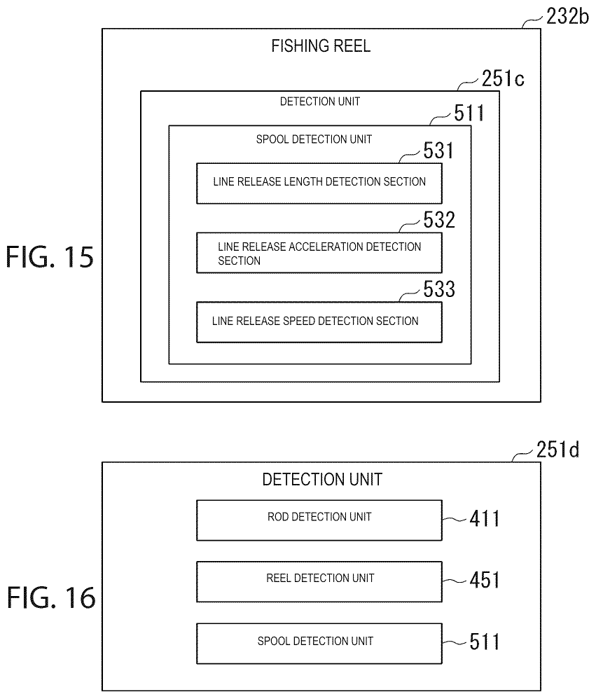

Here, the line release length detection section 531, the line release acceleration detection section 532, and the line release speed detection section 533 are the same as those shown in FIG. 15. The fishing reel 102, which is a dual-bearing reel, comprises the reel body B2 that can be mounted on a fishing rod (not shown but similar to fishing rod 101), the handle B3 that is attached to the reel body B2 so as to be rotatable around the handle axis O1, the spool B4 that can rotate around the spool axis O2 that is parallel to the handle axis O1 with respect to the reel body B2 and around which fishing line (not shown but similar to fishing line 103) is wound, and a clutch mechanism B5 that has a clutch operation lever B51.

The handle axis O1 and the spool axis O2 are arranged parallel to each other, and the direction along these axes (handle axis O1, spool axis O2) is defined as the left-right direction X. In addition, a direction perpendicular to the left-right direction X and that is along the direction in which the fishing line wound around the spool B4 is unreeled is defined as the front-rear direction Y. Furthermore, the direction perpendicular to both the left-right direction X and the front-rear direction Y is defined as the up-down direction Z. Of the front-rear direction Y, the direction in which the fishing line is unreeled from the spool B4 is defined as forward Y1, the opposite direction is defined as rearward Y2, and left and right are defined in relation to the fishing reel 102 as viewed from the rearward Y2 side (the angler's side). Accordingly, the example of FIG. 4 is a perspective view of the fishing reel 102 as viewed from diagonally above and from the front left.

In the present example, the spool axis O2 is positioned rearward Y2 and upward Z1 of the handle axis O1. The reel body B2 comprises a body frame part B20, and a side cover B21 that covers both the left and right sides of the body frame part B20.

The body frame part B20 is, for example, a molded piece made of synthetic resin or metal (for example, aluminum die-cast). The body frame part B20 has a right-side wall B20A and a left-side wall B20B arranged so as to face each other across the spool B4 in the left-right direction X, and a connecting member (not shown) that connects the right-side wall B20A and the left-side wall B20B in the left-right direction X.

The right-side wall B20A is disposed on the right side X1 relative to the spool B4 and supports the handle-side end of a spool shaft portion B41 so as to be rotatable. On the other hand, the left-side wall B20B is disposed on the left side X2 relative to the spool B4 and supports the non-handle side end of the spool shaft portion B41 so as to be rotatable. The handle B3 is disposed further on the right side X1 than the right-side wall B20A, and is attached to the body frame part B20 using the right-side wall B20A. Therefore, the fishing reel 102 is a right-hand handle type reel, and the outer surface of the left-side wall B20B is the palming side.

In the body frame part B20, at least the spool B4 and the clutch operation lever B51 are arranged between the right-side wall B20A and the left-side wall B20B. The side cover B21 includes a right side cover B21A that is combined with the body frame part B20 so as to cover the right-side wall B20A from the right side X1, and the left side cover B21B (cover portion) that is combined with the body frame part B20 so as to cover the left-side wall B20B from the left side X2.

An upper cover B23 is provided on the upper part of the body frame part B20. The upper cover B23 is, for example, disposed at the front part between the right-side wall B20A and the left-side wall B20B. The upper cover B23 is mainly provided with the display unit 13. The display unit 13 is composed of a counter, etc., that displays, on the top surface, various information such as the water depth of the rig.

The calculation unit 12 is composed of a microcomputer equipped with a CPU, for example, and carries out control as well as display control for causing the display unit 13 to display various types of information.

The spool B4 is disposed between the right-side wall B20A and the left-side wall B20B of the body frame part B20, and is supported by each of the right-side wall B20A and the left-side wall B20B so as to be rotatable around the spool axis O2 via shaft bearings (not shown).

The spool B4 includes the spool shaft portion B41 that rotates around the spool axis O2, and a bobbin trunk B42 that is disposed coaxially with the spool shaft portion B41 and that rotates in conjunction with the spool shaft portion B41. The two ends of the spool shaft portion B41 are supported by the body frame part B20 that supports the spool B4 so as to be rotatable.

### Example of a Display on the Display Unit

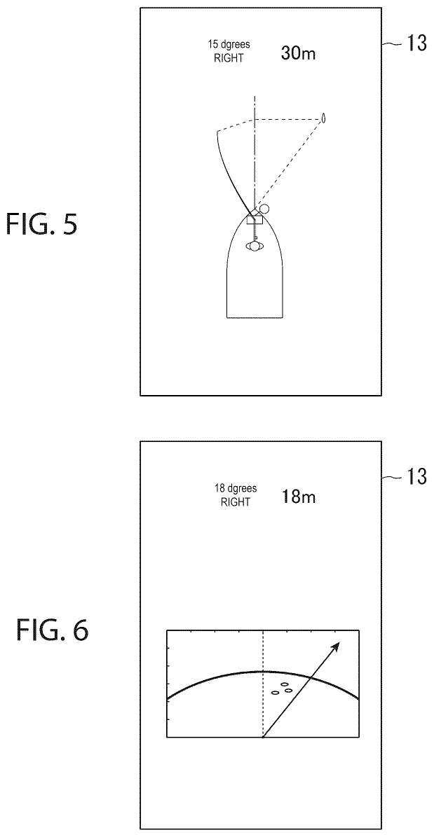

FIGS. 5 and 6 are diagrams showing examples of displays on the display unit according to the embodiment as fishing tackle. In the examples of FIGS. 3-6, the predicted water landing location of the rig 104 is displayed on a screen of the display unit 13 using distance [m]. In addition, the casting direction of the rig is shown. The casting direction can be an absolute direction using “north, south, east, and west” or a relative direction such as “45 degrees to the right.” FIGS. 3 and 4 show examples of displays indicating a predicted water landing location of “30 m in the ENE (east-northeast) direction.”

FIG. 5 shows an example of a display indicating a predicted water landing location of “15 degrees right, 30 m.” In addition, FIG. 5 also shows a state in which a ship, etc., is viewed from above with respect to the water surface.

FIG. 6 shows an example of a display indicating a predicted water landing location of “18 degrees right, 18 m.” In addition, FIG. 6 also shows a state underwater as viewed from above with respect to the water surface.

### Example Configuration of Fishing Rod

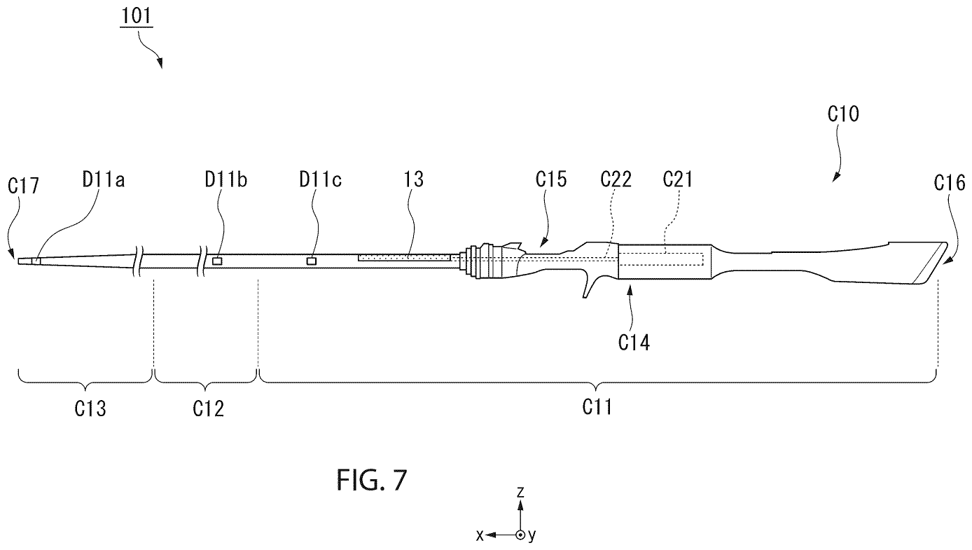

FIG. 7 is a diagram showing an example configuration of the fishing rod 101 according to the embodiment as fishing tackle. The fishing rod 101 has a rod body C10. The rod body C10 is the main body portion of the fishing rod 101. The rod body C10 includes a rod butt section C11, a rod middle section C12, and a rod tip section C13. The rod butt section C11 includes a grip C14 and a reel seat C15.

In the example shown in FIG. 7, the direction of each section is shown using three-dimensional Cartesian coordinates, with the direction from a rod butt C16 to a rod tip C17 of the rod body C10 (that is, the rod axis direction) as the x-axis, and the directions forming a plane perpendicular to the x-axis (that is, the cross section of the rod body C10) as the y-axis and the z-axis.

In the example shown in FIG. 7, the detection unit 11 (rod detector 11a) is provided on the fishing rod 101. This configuration is one example, and the number and installation locations of detectors can be freely selected.

A first rod detection unit D11a (one example of the rod detector 11a) is disposed near the rod tip C17 of the rod tip section C13. The rod detector 11a can be a sensor that detects the acceleration, speed, or angular velocity of the fishing rod 101.

A second rod detection unit D11b (one example of the rod detector 11a) is disposed on the rod middle section C12. The detection unit D11b can be a sensor that detects the direction of the fishing rod 101 or the position of the fishing rod 101.

A third rod detection unit D11c (one example of the rod detector 11a) is disposed on the rod butt section C11. The third rod detection unit D11c can be a sensor that detects the direction of the fishing rod 101 or the position of the fishing rod 101.

In addition, the example of FIG. 7 shows a control circuit C21 and a communication line C22 provided inside the fishing rod 101, and the display unit 13 provided on the surface of the fishing rod 101.

The control circuit C21 has, for example, the calculation unit 12 and a power source (not shown), such as a battery. The power source supplies power to the control circuit C21, the display unit 13, and the detection unit 11. The communication line C22 connects the control circuit C21 and the display unit 13 so as to be communicable with each other. The displayed content on the display unit 13 can be similar to that shown in FIG. 11, for example.

### Example of Predicting the Water Landing Location Based on Bending of the Fishing Rod

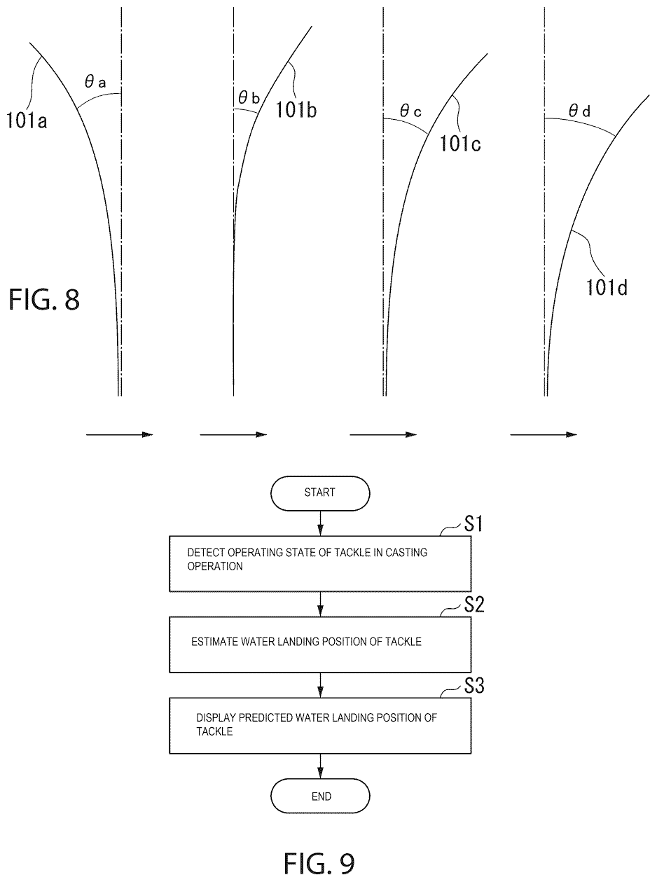

FIG. 8 is a diagram showing an example of water landing location prediction based on bending of the fishing rod 101 according to the embodiment as fishing tackle.

The present example shows a case in which the rod detector 11a of the fishing rod 101 detects the bending of the rod. In addition, in the present example, it is assumed that the fishing reel 102 is provided with the reel detector 11b that can detect when the fishing line 103 starts to be released. This reel detector 11b can be a detection unit that detects, for example, the release length, acceleration, or speed of the fishing line 103.

FIG. 8 shows a schematic view of the bending (flexing) state of the fishing rod 101 when the fishing line 103 is released as viewed from the side when casting, with the arrows pointing in the direction in which the rig is cast. The first pattern shows a state in which the fishing rod is swung up immediately before the rig is cast, in which the fishing rod 101a is flexed (bent) rearward at an angle of θa.

The second pattern shows a state after the rig has been cast in which the fishing rod 101b is flexed (bent) forward at an angle of θb due to the casting of the rig. The third pattern shows a state after the rig has been cast in which the fishing rod is flexed (bent) forward at an angle of θc due to the casting of the rig. The fourth pattern shows a state in which the rig has been cast and the fishing rod 101 of this example is flexed (bent) forward at a maximum angle of θd due to the casting of the rig.

In the present example, for example, compared to a case in which the fishing rod 101 flexes at angle θb of the second pattern as a result of casting the rig, the angle θb of the third pattern is larger and thus it is estimated that the rod was swung stronger and faster, and that the rig has flown farther. Furthermore, when the rod flexes at the maximum angle θd as shown in the fourth pattern, it can be estimated that the rig has flown even farther.

In addition, the second, third, and fourth patterns show examples in which the rig flight distance is estimated on the basis of the flex amount after casting, but the rig flight distance can also be estimated on the basis of the flex amount before casting, as in the first pattern.

In the present embodiment, a table representing the correspondence relationship between angles and the predicted water landing locations is stored in advance in the calculation unit 12. The calculation unit 12 calculates the water landing location on the basis of the table and the detected bend (bending angle in the present example).

### One Example of a Flow of Operation of the Fishing Tackle

FIG. 9 is a flowchart diagram showing one example of the flow of the operation of the fishing tackle 1 according to the embodiment as fishing tackle.

### Step S1

When an angler holds the fishing tackle 1 and carries out a casting operation of the fishing rig 104, the detection unit 11 detects the operating state of the fishing rig 104 in the casting operation.

### Step S2

The calculation unit 12 estimates the water landing location of the rig 104 that has been cast on the basis of the detection result of the detection unit 11.

### Step S3

The display unit 13 displays the predicted water landing location of the rig 104 estimated by the calculation unit 12.

Here, it is not necessary to carry out the process of (step S3). For example, if the fishing tackle 1 is not equipped with the display unit 13, the process of (step S3) is not carried out.

### Summary of the Embodiment as Fishing Tackle

As described above, in the embodiment as fishing tackle, as a result of the fishing tackle 1 being equipped with the detection unit 11 that detects the operating state of the fishing rig 104 in a casting operation, the water landing location of the rig 104 that has been cast can be accurately estimated.

In addition, in the embodiment as fishing tackle, the water landing location of the rig 104 that has been cast can be accurately estimated on the basis of the operating state of at least one of the fishing rod 101, the fishing reel 102, the fishing line 103, and the rig 104.

In addition, in the embodiment as fishing tackle, the water landing location of the rig 104 that has been cast can be accurately estimated on the basis of the operating states of a plurality of items among the fishing rod 101, the fishing reel 101, the fishing line 102, and the rig 104.

In addition, in the embodiment as fishing tackle, the water landing location of the rig 104 that has been cast can be accurately estimated by the calculation unit 12 provided in at least one of the fishing rod 101, the fishing reel 102, the fishing line 103, and the rig 104.

In addition, in the embodiment as fishing tackle, an angler, etc., can visually ascertain the predicted water landing location of the rig 104.

### Embodiment as Water Landing Location Estimation System

In the embodiment as a water landing location estimation system, a case is shown in which the calculation unit, which is provided in the fishing tackle in the embodiment as fishing tackle, is provided in a device other than the fishing tackle. In the embodiment as a water landing location estimation system, the display unit can be provided in a device other than the fishing tackle, or in the fishing tackle.

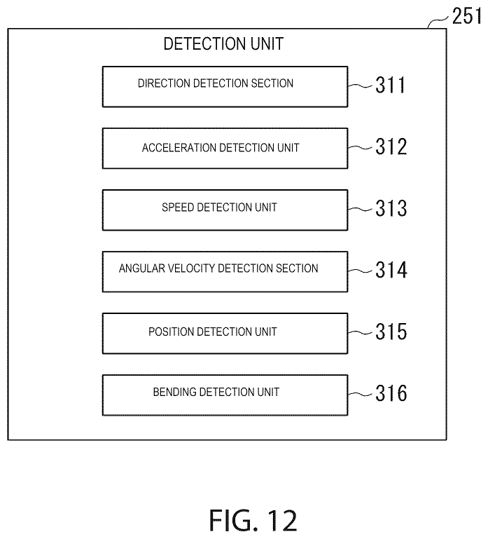

In addition, although the location where the calculation unit is provided is different between embodiment as a water landing location estimation system and the embodiment as fishing tackle, contents described in the respective embodiments can be applied to each other with respect to common components. For example, the example configuration of the detection unit (the example configurations according to each of FIGS. 12-16) illustrated in the embodiment as a water landing location estimation system can be applied to the detection unit according to the embodiment as fishing tackle.

### Example Configuration of the Water Landing Location Estimation System

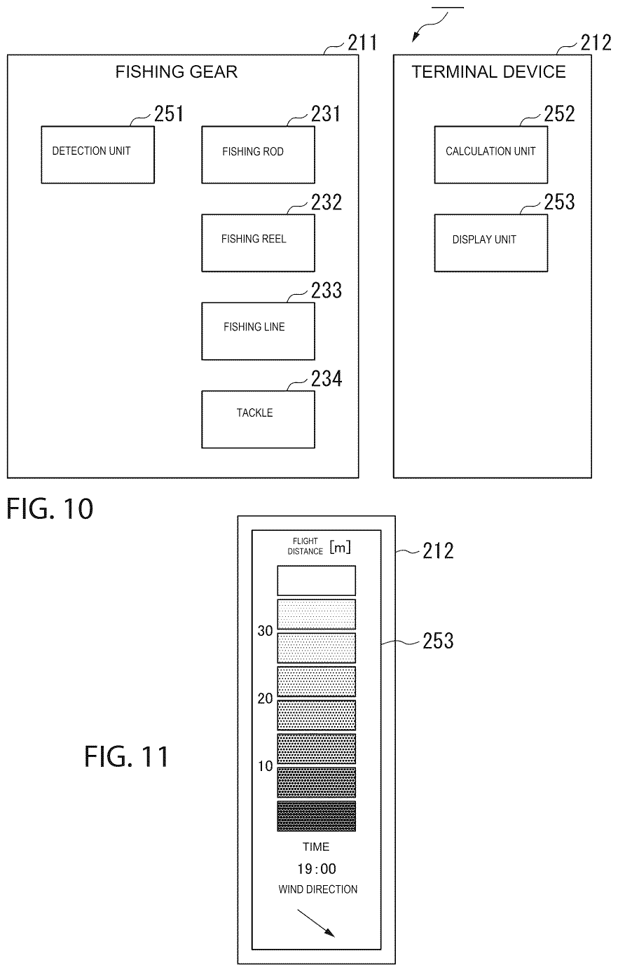

FIG. 10 is a diagram showing an example configuration of a water landing location estimation system 201 according to the embodiment as a water landing location estimation system.

The water landing location estimation system 201 comprises a fishing tackle 211 and a terminal device 212. The fishing tackle 211 comprises a fishing rod 231, a fishing reel 232, a fishing line 233, and a tackle 234. In addition, the fishing tackle 211 includes a detection unit 251. The terminal device 212 comprises a calculation unit 252 and a display unit 253.

Here, in the present embodiment, an example is shown in which the water landing location estimation system 201 comprises the display unit 253, but as another example, the water landing location estimation system 201 need not comprise the display unit 253.

The fishing tackle 211 can cast the fishing tackle 234 and has the detection unit 251. The detection unit 251 detects the operating state of the rig 234 in a casting operation. The calculation unit 252 estimates the water landing location of the rig 234 that has been cast on the basis of the detection result of the detection unit 251.

The display unit 253 displays the predicted water landing location of the rig 234 estimated by the calculation unit 252. Here, a schematic example of the fishing tackle 211 is the same as the example shown in FIG. 1 described in the embodiment as fishing tackle. In addition, in the same manner as the case of the embodiment as fishing tackle, the detection unit 251, the calculation unit 252, and the display unit 253 can be respectively configured by any piece of hardware.

In addition, in the same manner as the case of the embodiment as fishing tackle, the detection unit 251 and the calculation unit 252 can communicate with each other, and the calculation unit 252 and the display unit 253 can communicate with each other.

The terminal device 212 can be composed of any piece of hardware, such as a smartphone or a tablet. An example of a flow of operations of the detection unit 251, the calculation unit 252, and the display unit 253 is the same as the example shown in FIG. 9 described in the embodiment as fishing tackle.

### Example of Display on the Display Unit of the Terminal Device

FIG. 11 is a diagram showing an example of a display on the display unit 253 of the terminal device 212 according to the embodiment as a water landing location estimation system.

FIG. 11 shows an example in which the terminal device 212 is a smartphone. In the example of FIG. 11, the predicted water landing location is displayed on the display unit 253 of the terminal device 212 using a gauge meter that is pattern-coded by distance [m]. In addition, in the example of FIG. 11, the time and wind direction are also displayed.

### Example Configuration of the Detection Unit

FIG. 12 is a diagram showing an example configuration of the detection unit 251 according to the embodiment as a water landing location estimation system. The detection unit 251 includes a direction detection section 311, an acceleration detection section 312, a speed detection section 313, an angular velocity detection section 314, a position detection section 315, and a bending detection section 316.

The detection unit 251 can include at least one of the foregoing elements. The direction detection section 311 detects the direction of motion of the fishing tackle 211 in the casting operation of the rig 234. For example, the direction detection section 311 can be configured using a Global Positioning System (GPS) sensor, or another sensor such as an acceleration sensor. The direction of motion can be, for example, an absolute direction using latitude and longitude or a relative direction with respect to a prescribed reference direction.

The acceleration detection section 312 detects the acceleration applied to the fishing tackle 211 in the casting operation of the rig 234. The acceleration detection section 312 can be configured using an acceleration sensor, for example. The speed detection section 313 detects the speed of the fishing tackle 211 in the casting operation of the rig 234. The speed detection section 313 can be configured using a speed sensor, for example.

The angular velocity detection section 314 detects the angular velocity of the fishing tackle 211 in the casting operation of the rig 234. The angular velocity detection section 314 can be configured using an angular velocity sensor, for example.

The position detection section 315 detects the position of the fishing tackle 211 in the casting operation of the rig 234. For example, the position detection section 315 can be configured using a GPS sensor, or another sensor. The position can be, for example, an absolute position using latitude and longitude or a relative direction with respect to a prescribed reference position.

The bending detection section 316 detects the bending moment acting on the fishing tackle 211 in the casting operation of the rig 234. The bending detection section 316 can be configured using a moment sensor (or a bending sensor), for example.

Here, in the present embodiment, the direction detection section 311, the acceleration detection section 312, the speed detection section 313, the angular velocity detection section 314, the position detection section 315, and the bending detection section 316 are examples of components of the detection unit 251.

That is, if the detection unit 251 has one of the plurality of detection sections (the direction detection section 311, the acceleration detection section 312, the speed detection section 313, the angular velocity detection section 314, the position detection section 315, and the bending detection section 316), the detection section corresponds to the detection unit 251.

On the other hand, if the detection unit 251 has two or more of the plurality of detection sections (the direction detection section 311, the acceleration detection section 312, the speed detection section 313, the angular velocity detection section 314, the position detection section 315, and the bending detection section 316), the detection unit 251 is composed of the two or more detection sections.

### Example Configuration of Fishing Tackle Comprising a Plurality of Detection Sections

In the fishing tackle 211, the detection unit 251 may include a plurality of items among a plurality of the detection sections (direction detection section 311, acceleration detection section 312, speed detection section 313, angular velocity detection section 314, position detection section 315, and bending detection section 316).

The calculation unit 252 estimates the water landing location of the rig 234 that has been cast on the basis of the detection results of the plurality of detection sections.

Here, each detection section (direction detection section 311, acceleration detection section 312, speed detection section 313, angular velocity detection section 314, position detection section 315, and bending detection section 316) can be provided at any location on, for example, the fishing rod 231, the fishing reel 232, the fishing line 233, and the rig 234.

### Example Configuration of a Fishing Rod Having a Rod Detection Unit

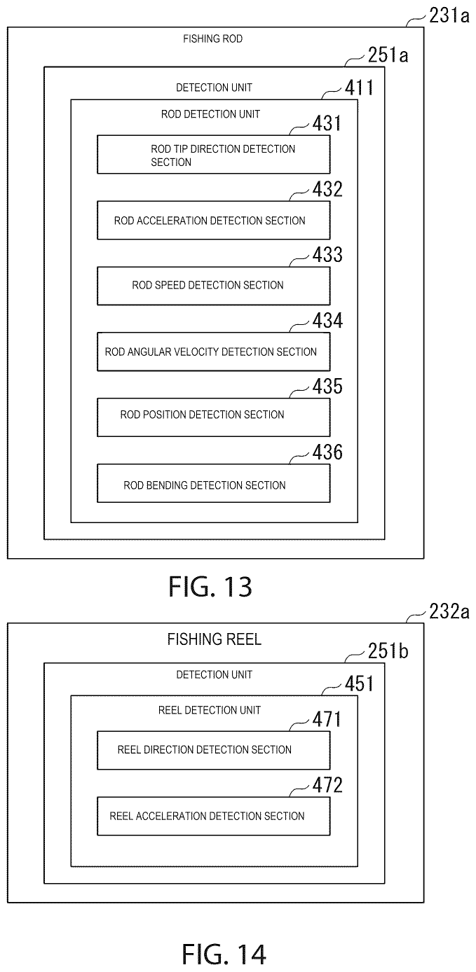

FIG. 13 is a diagram showing an example configuration of a fishing rod 231a including a rod detection unit 411 according to the embodiment as a water landing location estimation system.

The fishing tackle 211 can include a fishing rod 231a. A detection unit 251a can include the rod detection unit 411. The rod detection unit 411 is provided on the fishing rod 231a and detects the operating status of the fishing rod 231a in the casting operation of the rig 234.

Here, the fishing rod 231a is one example of the fishing rod 231 shown in FIG. 10. In addition, the detection unit 251a is one example of the detection unit 251 shown in FIG. 10. In the present example, the detection unit 251a is provided on the fishing rod 231a. The rod detection unit 411 includes a rod tip direction detection section 431, a rod acceleration detection section 432, a rod speed detection section 433, a rod angular velocity detection section 434, a rod position detection section 435, and a rod bending detection section 436.

The rod detection unit 411 can include at least one of the foregoing sections. The rod tip direction detection section 431 detects the direction of the rod tip of the fishing rod 231a in the casting operation of the rig 234. For example, the rod tip direction detection section 431 can be configured using a GPS sensor, or another sensor such as an acceleration sensor. The direction can be, for example, an absolute direction using latitude and longitude or a relative direction with respect to a prescribed reference direction.

The rod acceleration detection section 432 detects the acceleration of the fishing rod 231a in the casting operation of the rig 234. The rod acceleration detection section 432 can be configured using an acceleration sensor, for example. The rod speed detection section 433 detects the speed of the fishing rod 231a in the casting operation of the rig 234. The rod speed detection section 433 can be configured using a speed sensor, for example.

The rod angular velocity detection section 434 detects the angular velocity of the fishing rod 231a in the casting operation of the rig 234. The rod angular velocity detection section 434 can be configured using an angular velocity sensor, for example. The rod position detection section 435 detects the position of the fishing rod 231a in the casting operation of the rig 234. For example, the rod position detection section 435 can be configured using a GPS sensor, or another sensor. The position can be, for example, an absolute position using latitude and longitude or a relative direction with respect to a prescribed reference position.

The rod bending detection section 436 detects the bending moment acting on the fishing rod 231a in the casting operation of the rig 234. The rod bending detection section 436 can be configured using a moment sensor (or a bending sensor), for example.

### Example Configuration of a Fishing Reel Having a Reel Detection Unit

FIG. 14 is a diagram showing an example configuration of a fishing reel 232a including a reel detection unit 451 according to the embodiment as a water landing location estimation system. The fishing tackle 211 can include the fishing reel 232a. A detection unit 251b includes the reel detection unit 451. The reel detection unit 451 is provided on the fishing reel 232a and detects the operating status of the fishing rod 231 in the casting operation of the rig 234.

Here, the fishing reel 232a is one example of the fishing reel 232 shown in FIG. 10. In addition, the detection unit 251b is one example of the detection unit 251 shown in FIG. 10. In the present example, the detection unit 251b is provided on the fishing reel 232a. The reel detection unit 451 includes the reel direction detection section 471 and the reel acceleration detection section 472.

The reel detection unit 451 can include at least one of the foregoing sections. The reel direction detection section 471 detects the direction of the fishing reel 232a in the casting operation of the rig 234. For example, the reel direction detection section 471 can be configured using a GPS sensor, or another sensor such as an acceleration sensor. The direction can be, for example, an absolute direction using latitude and longitude or a relative direction with respect to a prescribed reference direction.

The reel acceleration detection section 472 detects the acceleration applied to the fishing reel 232a in the casting operation of the rig 234. The reel acceleration detection section 472 can be configured using an acceleration sensor, for example.

### Example Configuration of a Fishing Reel Having a Spool and a Spool Detection Unit

FIG. 15 is a diagram showing an example configuration of a fishing reel 232b including a spool and the spool detection unit 511 according to the embodiment as a water landing location estimation system.

The fishing tackle 211 can include the fishing reel 232b provided with a spool. The fishing line 233 is wound around the spool. A detection unit 251c includes the spool detection unit 511. The spool detection unit 511 is provided on the fishing reel 232b and detects the operation of the spool in the casting operation of the rig 234.

Here, the fishing reel 232b is one example of the fishing reel 232 shown in FIG. 10. In addition, the detection unit 251c is one example of the detection unit 251 shown in FIG. 10. In the present example, the detection unit 251c is provided on the fishing reel 232, and can be provided on the spool. The spool detection unit 511 includes the line release length detection section 531, the line release acceleration detection section 532, and the line release speed detection section 533.

The spool detection unit 511 can include at least one of the foregoing sections. The line release length detection section 531 detects the length of the fishing line 233 released from the spool in the casting operation of the rig 234. For example, the line release length detection section 531 can be configured using a sensor that detects the rotation amount of the spool, a sensor that detects the acceleration (for example, angular acceleration) of the rotation of the spool, or a sensor that detects the speed (for example, angular velocity) of the rotation of the spool. The line release acceleration detection section 532 detects the acceleration of the release of the fishing line 233 from the spool in the casting operation of the rig. For example, the line release acceleration detection section 532 can be configured using a sensor that detects the acceleration (for example, angular acceleration) of the rotation of the spool.

The line release speed detection section 533 detects the speed at which the fishing line 233 is released from the spool in the casting operation of the rig. For example, the line release speed detection section 533 can be configured using a sensor that detects the speed (for example, angular velocity) of the rotation of the spool.

### Example Configuration of Fishing Tackle Comprising a Plurality of Items Among a Rod Detection Unit, a Reel Detection Unit, and a Spool Detection Unit

FIG. 16 is a diagram showing an example configuration of a detection unit 251d including the rod detection unit 411, the reel detection unit 451, and the spool detection unit 511, according to the embodiment as a water landing location estimation system.

Here, the detection unit 251d is one example of the detection unit 251 shown in FIG. 10. The fishing tackle 211 includes the fishing rod 231a and the fishing reel 232b (in the present example, the fishing reel 232b also functions as the fishing reel 232a). The fishing reel 232b is attached to the fishing rod 231a and is provided with a spool around which the fishing line 233 is wound. The detection unit 251d includes the rod detection unit 411, the reel detection unit 451, and the spool detection unit 511.

The detection unit 251d can include any two of the foregoing units. The rod detection unit 411 is provided on the fishing rod 231a and detects the operating status of the fishing rod 231a in the casting operation of the rig 234. The reel detection unit 451 is provided on the fishing reel 232b and detects the operating status of the fishing reel 232b in the casting operation of the rig 234. The spool detection unit 511 is provided on the fishing reel 232b and detects the operation of the spool in the casting operation of the rig 234.

The calculation unit 252 estimates the water landing location of the rig 234 that has been cast on the basis of the detection results of the plurality of detectors (rod detection unit 411, reel detection unit 451, and spool detection unit 511).

### First Modified Example of the Embodiment as a Water Landing Location Estimation System

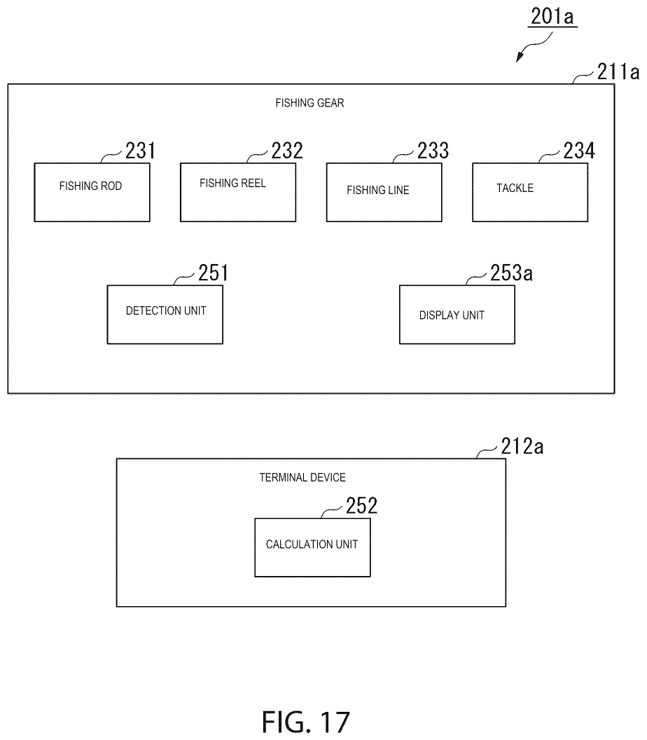

FIG. 17 is a diagram showing an example configuration of a water landing location estimation system 201a according to a first modified example of the embodiment as a water landing location estimation system.

The water landing location estimation system 201a comprises a fishing tackle 211a and a terminal device 212a. The fishing tackle 211a comprises the fishing rod 231, the fishing reel 232, the fishing line 233, and the rig 234. The fishing tackle 211a also comprises the detection unit 251 and the display unit 253.

The terminal device 212a includes the calculation unit 252. Here, the configuration of the water landing location estimation system 201a is different from the water landing location estimation system 201 shown in FIG. 10 in the point that the function of the display unit 253a is provided in the fishing tackle 211a instead of the terminal device 212a, but is otherwise the same.

### Second Modified Example of the Embodiment as a Water Landing Location Estimation System

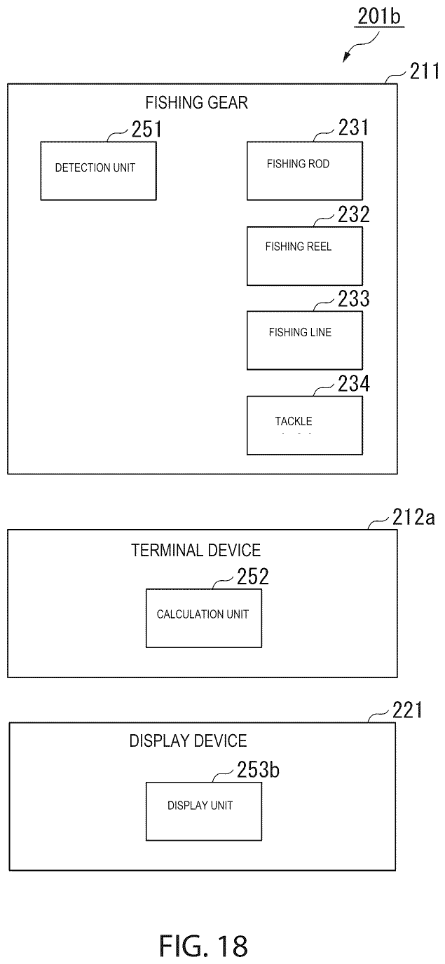

FIG. 18 is a diagram showing an example configuration of a water landing location estimation system 201b according to a second modified example of the embodiment as a water landing location estimation system.

The water landing location estimation system 201b comprises the fishing tackle 211, the terminal device 212a, and a display device 221. The fishing tackle 211 comprises a fishing rod 231, a fishing reel 232, a fishing line 233, and a tackle 234. In addition, the fishing tackle 211 includes a detection unit 251. The terminal device 212a includes the calculation unit 252. The display device 221 has a display unit 253b.

Here, the configuration of the water landing location estimation system 201b is different from the water landing location estimation system 201 shown in FIG. 10 in the point that the function of the display unit 253b is provided in the display device 221 instead of the terminal device 212a, but is otherwise the same.

The display device 221 can be composed of any piece of hardware, and is a device different from the terminal device 212a in the example of FIG. 18, such as any display device having a display screen, or a computer having a display screen such as a tablet.

### Summary of the Embodiment as a Water Landing Location Estimation System

In the embodiment as a water landing location estimation system, as a result of the fishing tackle 211 being equipped with the detection unit 251 that detects the operating state of the fishing tackle 234 in a casting operation, the water landing location of the rig 234 that has been cast can be accurately estimated.

In addition, in the embodiment as a water landing location estimation system, the water landing location of the rig 234 that has been cast can be accurately estimated on the basis of at least one of the direction of motion of the fishing tackle 211 in the casting operation of the rig 234, the acceleration applied to the fishing tackle 211 in the casting operation of the rig 234, the speed of the fishing tackle 211 in the casting operation of the rig 234, the angular velocity of the fishing tackle 211 in the casting operation of the rig 234, the position of the fishing tackle 211 in the casting operation of the rig 234, and the bending moment acting on the fishing tackle 211 in the casting operation of the rig 234.

In addition, in the embodiment as a water landing location estimation system, the water landing location of the rig 234 that has been cast can be accurately estimated on the basis of a plurality of criteria among the direction of motion of the fishing tackle 211 in the casting operation of the rig 234, the acceleration applied to the fishing tackle 211 in the casting operation of the rig 234, the speed of the fishing tackle 211 in the casting operation of the rig 234, the angular velocity of the fishing tackle 211 in the casting operation of the rig 234, the position of the fishing tackle 211 in the casting operation of the rig 234, and the bending moment acting on the fishing tackle 211 in the casting operation of the rig 234.

In addition, the embodiment as a water landing location estimation system includes the rod detection unit 411 that detects the operating status of the fishing rod 231 in the casting operation of the rig 234, and the water landing location of the rig 234 that has been cast can be accurately estimated on the basis of at least one of the direction of the rod tip of the fishing rod 231 in the casting operation of the rig 234, the acceleration of the fishing rod 231 in the casting operation of the rig 234, the speed of the fishing rod 231 in the casting operation of the rig 234, the angular velocity of the fishing rod 231 in the casting operation of the rig 234, the position of the fishing rod 231 in the casting operation of the rig 234, and the bending moment acting on the fishing rod 231 in the casting operation of the rig 234.

In addition, the embodiment as a water landing location estimation system includes the reel detection unit 451 that detects the operating status of the fishing reel 232 in the casting operation of the rig 234, and the water landing location of the rig 234 that has been cast can be accurately estimated on the basis of the direction of the fishing reel 232 in the casting operation of the rig 234 and/or the acceleration applied to the fishing reel 232 in the casting operation of the rig 234.

The embodiment as a water landing location estimation system includes the spool detection unit 511 that detects the operation of the spool in the casting operation of the rig 234, and the water landing location of the rig 234 that has been cast can be accurately estimated on the basis of at least one of the length of the fishing line 233 released from the spool in the casting operation of the rig 234, the acceleration of the fishing line 233 released from the spool in the casting operation of the rig 234, and the speed of the fishing line 233 released from the spool in the casting operation of the rig 234.

In addition, in the embodiment as a water landing location estimation system, the water landing location of the rig 234 that has been cast can be accurately estimated on the basis of a plurality of criteria among the operating status of the fishing rod 231 in the casting operation of the rig 234, the operating status of the fishing reel 232 in the casting operation of the rig 234, and the operation of the spool in the casting operation of the rig 234.

In addition, in the embodiment as a water landing location estimation system, an angler, etc., can visually ascertain the predicted water landing location of the rig 234.

### Embodiment As Fishing Assistance System

In the embodiment as a fishing assistance system, a case is shown in which an underwater detection unit and a control unit (controller) are further provided with respect to the embodiment as fishing tackle or the embodiment as a water landing location estimation system. In the embodiment as a fishing assistance system, the calculation unit and the display unit can be respectively provided in a device other than the fishing tackle, or in the fishing tackle.

In addition, although the embodiment as a fishing assistance system is different from the embodiment of the fishing tackle and the embodiment as a water landing location estimation system in the point of having an underwater detection unit and a control unit (controller), contents described in the respective embodiments can be applied to each other with respect to common components. For example, the example configuration of the detection unit (the example configurations according to each of FIGS. 12-16) illustrated in the embodiment as a water landing location estimation system can be applied to the detection unit according to the embodiment as a fishing assistance system.

### Example Configuration of the Fishing Assistance System

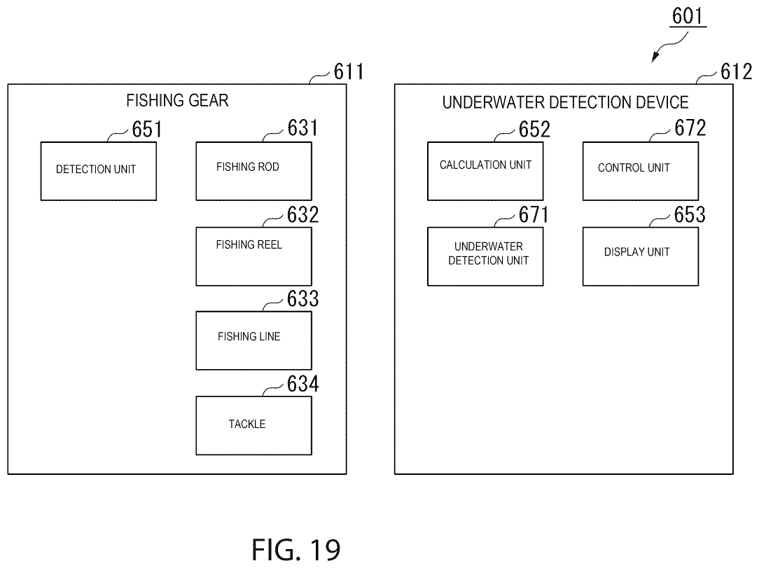

FIG. 19 is a diagram showing an example configuration of a fishing assistance system 601 according to the embodiment as a fishing assistance system. The fishing assistance system 601 comprises a fishing tackle 611 and an underwater detection device 612. The fishing tackle 611 comprises a fishing rod 631, a fishing reel 632, a fishing line 633, and a tackle 634. In addition, the fishing tackle 611 includes a detection unit 651.

The underwater detection device 612 comprises a calculation unit 652, a display unit 653, an underwater detection unit 671, and a control unit 672. Here, in the present embodiment, an example is shown in which the fishing tackle 601 comprises the display unit 653, but as another example, the fishing tackle 601 need not comprise the display unit 653.

Various devices can be used as the underwater detection device 612, such as a forward facing sonar (FFS) device, which is a fish finder that looks forward, and the display of the fish finder screen can be optimized by linking the FFS with information on the predicted water landing location.

The detection unit 651 detects the operating state of the fishing tackle 634 in a casting operation. The calculation unit 652 estimates the water landing location of the rig 634 that has been cast on the basis of the detection result of the detection unit 651.

The underwater detection unit 671 detects target objects under water. A target object can be, for example, fish or a school of fish. The control unit 672 controls the underwater detection unit 671 on the basis of the calculation result of the calculation unit 652. Various controls can be carried out as the control.

The display unit 653 displays the predicted water landing location of the rig 634 estimated by the calculation unit 652. In addition, the display unit 653 can display an underwater target object detected by the underwater detection unit 671, and can further display other information.

Such processing from detection to display can be carried out in real time during actual fishing, for example. Here, a schematic example of the fishing tackle 611 is the same as the example shown in FIG. 1 described in the embodiment as fishing tackle. In addition, in the same manner as the case of the embodiment as fishing tackle, the detection unit 651, the calculation unit 652, and the display unit 653 can be respectively configured by any piece of hardware.

In addition, in the same manner as the case of the embodiment as fishing tackle, the detection unit 651 and the calculation unit 652 can communicate with each other, and the calculation unit 652 and the display unit 653 can communicate with each other.

In addition, in the present embodiment, the calculation unit 652 and the control unit 672 can communicate with each other, and the control unit 672 and the underwater detection unit 671 can communicate with each other. The other components can also be capable of communicating with each other. The communications can be, for example, wireless communication or wired communication.

Here, the example of FIG. 19 shows a case in which the underwater detection device 612 equipped with the underwater detection unit 671 is provided with the calculation unit 652, the display unit 653, and the control unit 672; however, as another example configuration, at least one of the calculation unit 652, the display unit 653, and the control unit 672 can be provided in a location other than the underwater detection device 612.

For example, one or more components among the calculation unit 652, the display unit 653, and the control unit 672, can be respectively provided in the fishing tackle 611 or a terminal device such as a smartphone (not shown in FIG. 12).

### Example of State of Casting a Tackle

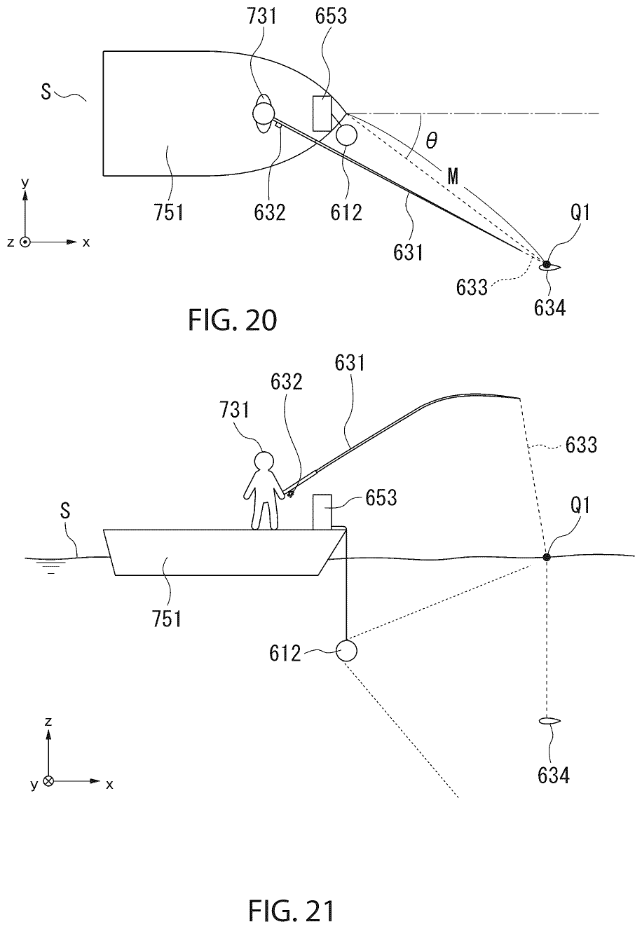

FIGS. 20 and 21 are diagrams respectively showing an example of a state in which the rig 634 is cast in the embodiment as a fishing assistance system. Here, for the sake of convenience, an xyz Cartesian coordinate system is shown in FIGS. 20 and 21.

FIGS. 20 and 21 show a water surface S, the fishing rod 631, the fishing reel 632, the fishing line 633, and the rig 634 constituting the fishing tackle 611, the underwater detection device 612, an angler 731, and a ship 751 sailing on the water surface S.

Here, the underwater detection device 612 is provided at the distal end portion of the ship 751. In addition, in the present example, the display unit 653 of the underwater detection device 612 is provided on the ship 751. The angler 731 is onboard the ship 751 and is fishing while holding the fishing tackle 611. When the angler 731 holds the fishing tackle 611 and carries out a casting operation of the fishing tackle 634, the rig 634 is cast and lands on water at a water landing location Q1 on the water surface S. The examples shown in FIGS. 20 and 21 show a state in which the rig 634 landed on, and then sunk under, water.

Here, for example, taking the bow of the ship 751 (in the present example, positive side end on the x-axis) as a reference position and the direction heading from the reference position toward the front of the ship 751 (direction parallel to the x-axis) as the 0-degree direction, an angle θ of the direction from the reference position toward the water landing location Q1 is determined. In addition, for example, the distance M from the reference position to the water landing location Q1 is determined.

In the examples shown in FIGS. 20 and 21, the position of the rig 634 is included in the detection range of the underwater detection device 612.

### Example of Display on the Display Unit of the Underwater Detection Device

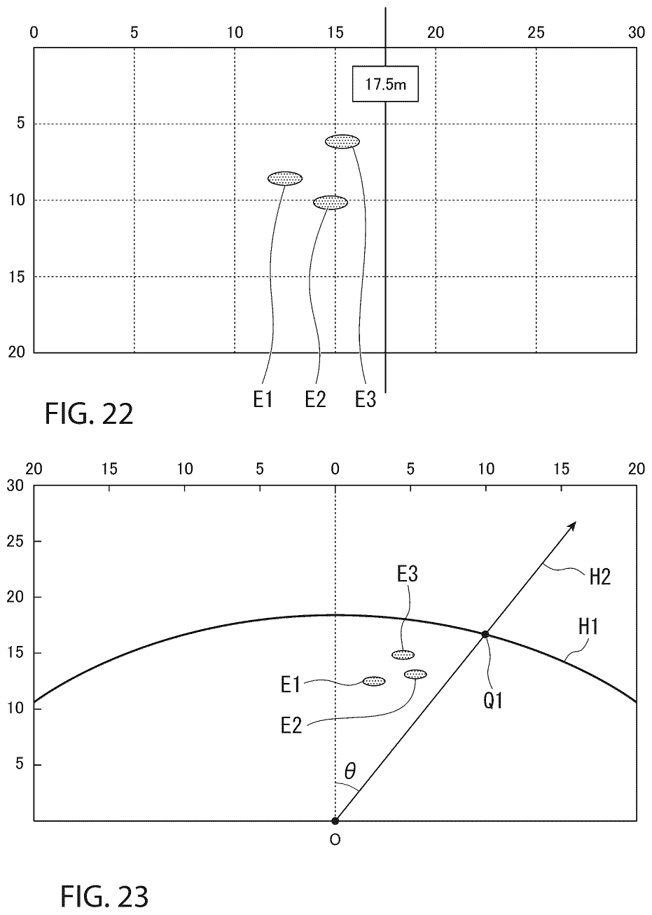

FIGS. 22 and 23 are diagrams respectively showing an example of a display on the display unit 653 of the underwater detection device 612 according to the embodiment as a fishing assistance system.

FIG. 22 is an example of a display when the water surface S is viewed horizontally, as in FIG. 21. In FIG. 22, the horizontal axis represents the distance of the ship 751 heading forward from the reference position, and the vertical axis represents depth, which increases downward with the water surface S as the reference.

In the example shown in FIG. 22, a result is displayed in which the distance M to the water landing location of the rig 634 is predicted to be 17.5 [m]. In the example shown in FIG. 22, detected objects E1-E3 estimated to be fish are shown as objects (detected objects) detected by the underwater detection unit 671.

FIG. 23 is an example of a display when the water surface S is viewed from vertically above, as in FIG. 20. In FIG. 23, with the origin O as the reference position, a distance scale is shown on the vertical axis and a rotation angle scale is shown on the horizontal axis. The direction upward form the origin O in the vertical direction (0-degree direction) corresponds to the direction of the ship 751 heading forward from the reference position.

The intersection of the circumference of a circle H1 having the origin O as the center and the distance M to the water landing location of the rig 634 as the radius, and a line drawn from the origin O toward the rotational angle (angle θ) direction H2 corresponds to the water landing location Q1. In the example of FIG. 23, detected objects E1-E3 are shown in the same manner as in the example of FIG. 22.

### Example of Control of the Underwater Detection Unit

The control unit 672 controls the detection direction of the underwater detection unit 671 on the basis of the calculation result of the calculation unit 652. The control unit 672 can control the detection distance of the underwater detection unit 671 on the basis of the calculation result of the calculation unit 652.

For example, in the examples of FIGS. 20-23, the control unit 672 can control the detection direction and the detection distance of the underwater detection unit 671 such that the rig 634 would be included in the detection range of the underwater detection unit 671, on the basis of the water landing location Q1 of the rig 634. Here, the detection direction can be expressed using an angle relative to the reference direction, for example.

### Example of Detection of Relationship Between Orientation of the Fishing Rod and Orientation of the Ship

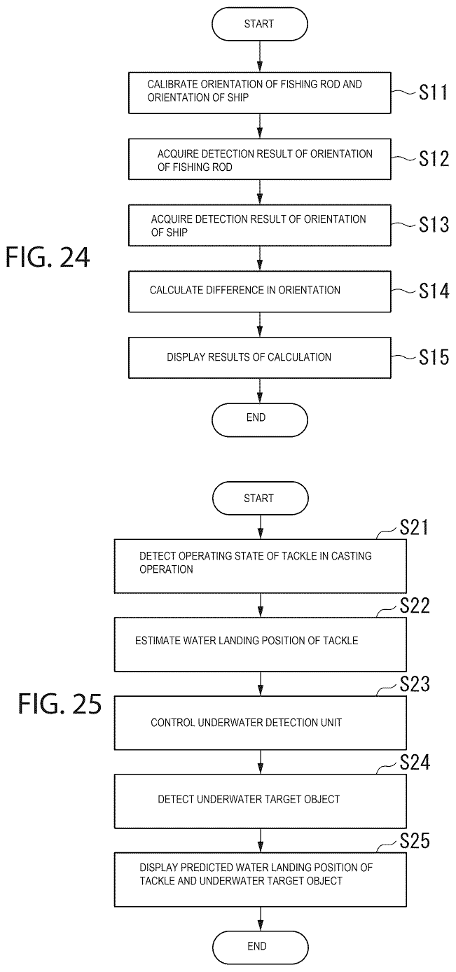

FIG. 24 is a flowchart diagram showing one example of a flow of an operation for obtaining and displaying the relationship between the orientation of the fishing rod 631 and the orientation of the bow of a ship according to the embodiment as a fishing assistance system.

In the present example, it is assumed that a detection unit (such as a gyro sensor) that can ascertain the orientation of the ship 751 is provided in the examples shown in FIGS. 20 and 21, and the detection unit 651 (for example, a gyro sensor) that can ascertain the orientation is provided on the fishing rod 631 of the fishing tackle 611.

### Step S11

The calculation unit 652 calibrates the orientation of the fishing rod 631 and the orientation of the ship 751 on the basis of the detection result of the orientation of the fishing rod 631 and the detection result of the orientation of the ship 751.

At this time, for example, the orientation of the fishing rod 631 toward the rod tip and the orientation toward the front of the ship 751 can be the same.

### Step S12

Thereafter, the calculation unit 652 acquires the detection result of the orientation of the fishing rod 631.

### Step S13

The calculation unit 652 acquires the detection result of the orientation of the ship 751.

Here, the process of (step S12) and the process of (step S13) can be carried out in reverse order, or be carried out simultaneously.

### Step S14

The calculation unit 652 calculates the difference between the orientation of the fishing rod 631 and the orientation of the ship 751.

### Step S15

The calculation unit 652 displays the calculation result (difference in orientation) on the display unit 653.

### One Example of a Flow of the Operation of the Fishing Assistance System

FIG. 25 is a flowchart diagram showing one example of a flow of an operation of the fishing assistance system 601 according to the embodiment as a fishing assistance system.

### Step S21

When an angler holds the fishing tackle 611 and carries out a casting operation of the fishing tackle 634, the detection unit 651 detects the operating state of the fishing tackle 634 in the casting operation.

### Step S22

The calculation unit 652 estimates the water landing location of the rig 634 that has been cast on the basis of the detection result of the detection unit 651.

### Step S23

The control unit 672 controls the underwater detection unit 671 on the basis of the calculation result of the calculation unit 652.

### Step S24

The underwater detection unit 671 detects target objects under water.

### Step S25

The display unit 653 displays the predicted water landing location of the rig 634 estimated by the calculation unit 652, and the underwater target object that has been detected.

Here, it is not necessary to carry out the process of (step S25). For example, if the fishing assistance system 601 is not equipped with the display unit 653, the process of (step S25) is not carried out.

### Example Configuration of the Detection Unit

The detection unit 651 is provided on at least one of the fishing rod 631, the fishing reel 632 attached to the fishing rod 631, a fishing line wound around the fishing reel 632 or released from the fishing reel 632, and the rig 634 attached to the fishing line 633. A plurality of the detectors 651 can be provided on any of the fishing rod 631, the fishing reel 632, the fishing line 633, and the rig 634. In this case, the calculation unit 652 estimates the water landing location of the rig 634 that has been cast on the basis of the detection results of the plurality of detectors.

The detection unit 651 can comprise a plurality of items among the rod detection unit, the reel detection unit, and the spool detection unit. In this case, the calculation unit 652 estimates the water landing location of the rig 634 that has been cast on the basis of the detection results of the plurality of detectors.

Here, the rod detection unit is provided on the fishing rod 631 and detects the operating status of the fishing rod 631 in the casting operation of the rig 634. The reel detection unit is provided on the fishing reel 632 and detects the operating status of fishing reel 632 in the casting operation of the rig 634. The spool detection unit is provided on the fishing reel 632 and detects the operation of the spool in the casting operation of the rig 634.

### Summary of the Embodiment as a Fishing Assistance System

In the embodiment as a fishing assistance system, as a result of the fishing tackle 611 being equipped with the detection unit 651 that detects the operating state of the fishing tackle 634 in a casting operation, the water landing location of the rig 634 that has been cast can be accurately estimated, thereby assisting fishing.

In addition, in the embodiment as a fishing assistance system, the detection direction in which an underwater target object is detected can be appropriately controlled in accordance with the water landing location of the rig 634 that has been cast.

In addition, in the embodiment as a fishing assistance system, the detection distance at which an underwater target object is detected can be appropriately controlled in accordance with the water landing location of the rig 634 that has been cast.

In addition, in the embodiment as a fishing assistance system, the water landing location of the rig 634 that has been cast can be accurately estimated on the basis of the operating state of at least one of the fishing rod 631, the fishing reel 632, the fishing line 633, and the rig 634.

In addition, in the embodiment as a fishing assistance system, the water landing location of the rig 634 that has been cast can be accurately estimated on the basis of the operating states of a plurality of items among the fishing rod 631, the fishing reel 632, the fishing line 633, and the rig 634.

In addition, in the embodiment as a fishing assistance system, the water landing location of the rig 634 that has been cast can be accurately estimated on the basis of a plurality of criteria among the operating status of the fishing rod 631 in the casting operation of the rig 634, the operating status of the fishing reel 632 in the casting operation of the rig 634, and the operation of the spool in the casting operation of the rig 634.

In addition, in the embodiment as a fishing assistance system, an angler, etc., can visually ascertain the predicted water landing location of the rig 634.

Here, the background art and problems associated with the present embodiment will be described in detail.

In general, underwater detection devices such as fish finders emit ultrasonic waves toward the seabed from a transducer attached to a ship, receive, with the transducer, reflected waves reflected off of fish or schools of fish, structures such as artificial reefs, or underwater topography such as reefs in the water, and analyzes the received signals to detect target objects.

Here, fish finders are mainly used on fishing vessels or boats for fishing in the ocean, but are recently starting to be used for boat fishing in rivers, lakes, reservoirs, etc., as a hobby or a sport. As a result, boat fishing methods in rivers, lakes, reservoirs etc., using small vessels are changing from the conventional style of fishing while looking at the water surface to a style in which fishing is carried out while checking the rig that has been cast (such as a lure) and an image of the target fish on the screen of the fish finder.

However, even when ultrasonic waves are emitted from the transducer attached to a ship toward the seabed in a substantially vertical direction, if the orientation or the position of the ship changes due to the tide, water current, waves, wind direction, etc., the orientation of the transducer of the underwater detection device attached to the ship changes, thereby causing the problem of not being able to detect target objects. In addition, even if first information (water depth information of the rig) related to the fishing reel is displayed in a detailed mode, it is extremely difficult to detect a tackle that has been cast with the underwater detection device, and, even if the rig that has been cast could be detected with the underwater detection device, it is even more difficult to visually check the rig on the display screen.

Moreover, when emitting ultrasonic waves forward (lateral direction), the detection width (angle) is extremely narrow, between 15 to 30 degrees, it is extremely difficult to detect the rig that has been cast with the underwater detection device.

Furthermore, even if the configuration is such that the target object (for example, signs of fish or a reef) is automatically tracked, casting the rig to the vicinity of the target object (for example, within the detection width or the detection area) requires experience and skill of the angler (user), which cannot be effectively used

In the present embodiment, such conventional problems can be solved by providing fishing tackle with a sensor that detects motions thereof, and the water landing location of the rig that has been cast can be estimated on the basis of the detection result of the sensor.

### Regrading Each Component

A program for realizing the function of any component described above can be stored in a computer-readable storage medium, and the program can be read into and executed by a computer system. The “computer system” here includes the operating system and hardware such as peripheral devices. Further, the “computer-readable storage medium” refers to storage devices such as portable media like flexible discs, magneto-optical discs, ROM, CD (Compact Disc)-ROM (Read Only Memory), or hard disks built into the computer system. In addition, the “computer-readable storage medium” also includes media that retain programs for a set period of time, such as volatile memory inside a computer system that constitutes a server or a client, when the program is transmitted via a network such as the Internet or a communication line, such as a telephone line. The volatile memory can be RAM (Random Access Memory), for example. The storage medium can be a non-transitory storage medium, for example.

In addition, the program described above can be transmitted from a computer system that stores the program in a storage device, etc., to another computer system via a transmission medium, or by transmission waves in a transmission medium. Here, a “transmission medium” that transmits a program refers to a medium having the function of transmitting information, such as a network such as the Internet or a communication line such as a telephone line.

In addition, the above-described program can realize some of the above-described functions. Moreover, the program can be a program that can realize the above-mentioned functions by being combined with a program that is already stored in the computer system, i.e., a so-called difference file. The difference file can be referred to as a difference program.

In addition, the function of any of the components described above can be realized by a processor. For example, each process in the embodiments can be realized by a processor that is operated on the basis of information, such as a program, and a computer-readable storage medium that stores information, such as a program. Here, in the processor, the functions of each part can be realized by individual hardware, or the functions of each part can be realized by integrated hardware. For example, the processor can include hardware, and the hardware can include a circuit for processing digital signals and/or a circuit for processing analog signals. For example, the processor can be configured using one or more circuit devices mounted on a circuit board and/or one or more circuit elements. An IC (integrated circuit) can be used as the circuit device, and resistors, capacitors, etc., can be used as the circuit elements.

Here, the processor can be, for example, a CPU. However, the processors is not limited to a CPU, and various processors can be used, such as a GPU (Graphics Processing Unit) or a DSP (Digital Signal Processor). In addition, the processor can be a hardware circuit using an ASIC (Application Specific Integrated Circuit). In addition, the processor can be composed of a plurality of CPUs, or be composed of a hardware circuit using a plurality of ASICs. In addition, the processor can be composed of a combination of a plurality of CPUs and a hardware circuit using a plurality of ASICs. In addition, the processor can include an amplifier circuit and/or a filter circuit that processes analog signals.

The embodiments of the present disclosure have been described above with reference to the drawings, but the specific configurations are not limited to these embodiments, and the present disclosure includes designs, etc., that do not depart from the scope of the disclosure.

What is claimed is:

1. Fishing tackle, comprising:
a detection unit configured to detect an operating state of a fishing tackle in a casting operation; and
a calculation unit configured to estimate a water landing location of a rig that has been cast based on a detection result of the detection unit.

2. The fishing tackle according to claim 1, wherein
the detection unit is provided on at least one of a fishing rod, a fishing reel attached to the fishing rod, fishing line wound on or released from the fishing reel, and the rig attached to the fishing line.

3. The fishing tackle according to claim 1, wherein
the detection unit is one of a plurality of the detectors provided on any of a fishing rod, a fishing reel attached to the fishing rod, a fishing line wound around the fishing reel or released from the fishing reel, and the rig attached to the fishing line, each detection unit of the plurality of detectors configured to provide detection results, and
the calculation unit is configured to estimate a water landing location of the rig based on the detection results of the plurality of detectors.

4. The fishing tackle according to claim 1, wherein
the calculation unit is provided on at least one of a fishing rod, a fishing reel attached to the fishing rod, fishing line wound around the fishing reel or released from the fishing reel, and the rig attached to the fishing line.

5. The fishing tackle according to claim 1, further comprising
a display unit configured to display a prediction of the water landing location of the rig estimated by the calculation unit.

6. A water landing location estimation system, comprising
fishing tackle configured to cast fishing tackle and having a detection unit configured to detect an operating state of a rig in a casting operation, and
a calculation unit configured to estimate a water landing location of the rig that has been cast based on a detection result of the detection unit.

7. The water landing location estimation system according to claim 6, wherein
the detection unit has at least one of a direction detection section configured to detect a direction of motion of the fishing tackle in the casting operation of the rig, an acceleration detection section configured to detect an acceleration applied to the fishing tackle in the casting operation of the rig, a speed detection section configured to detect a speed of the fishing tackle in the casting operation of the rig, an angular velocity detection section configured to detect an angular velocity of the fishing tackle in the casting operation of the rig, a position detection section configured to detect ae position of the fishing tackle in the casting operation of the rig, and a flexing detection section configured to detect a flexing moment acting on the fishing tackle in the casting operation of the rig.

8. The water landing location estimation system according to claim 6, wherein
the detection unit a plurality of detections section selected from a direction detection section configured to detect a direction of motion of the fishing tackle in the casting operation of the rig, an acceleration detection section configured to detect an acceleration applied to the fishing tackle in the casting operation of the rig, a speed detection section configured to detect a speed of the fishing tackle in the casting operation of the rig, an angular velocity detection section configured to detect a angular velocity of the fishing tackle in the casting operation of the rig, a position detection section configured to detect a position of the fishing tackle in the casting operation of the rig, and a flexing detection section configured to detect a flexing moment acting on the fishing tackle in the casting operation of the rig, and
the calculation unit is configured to estimate the water landing location of the rig that has been cast based on detection results of the plurality of detection section.

9. The water landing location estimation system according to claim 6, wherein
the fishing tackle includes a fishing rod,
the detection unit includes a rod detection unit provided on the fishing rod and configured to detect an operating status of the fishing rod in the casting operation of the rig, and
the rod detection unit includes at least one of
a rod tip direction detection section configured to detect a direction of a rod tip of the fishing rod in the casting operation of the rig,
a rod acceleration detection section configured to detect an acceleration of the fishing rod in the casting operation of the rig,
a rod speed detection section configured to detect a speed of the fishing rod in the casting operation of the rig,
a rod angular velocity detection section configured to detect an angular velocity of the fishing rod in the casting operation of the rig,
a rod position detection section configured to detect a position of the fishing rod in the casting operation of the rig, and
a rod flexing detection section configured to detect a flexing moment acting on the fishing rod in the casting operation of the rig.

10. The water landing location estimation system according to claim 6, wherein
the fishing tackle includes a fishing reel,
the detection unit includes a reel detection unit provided on the fishing reel and configured to detect an operating status of the fishing reel in the casting operation of the rig, and
the reel detection unit includes
a reel direction detection section configured to detect a direction of the fishing reel in the casting operation of the rig, or
a reel acceleration detection section configured to detect an acceleration applied to the fishing reel in the casting operation of the rig.

11. The water landing location estimation system according to claim 6, wherein
the fishing tackle includes a fishing reel provided with a spool around which a fishing line is capable of being wound,
the detection unit includes a spool detection unit provided on the fishing reel and configured to detect an operation of the spool in the casting operation of the rig, and the spool detection unit includes at least one of
a line release length detection section configured to detect a length of the fishing line released from the spool in the casting operation of the rig,
a line release acceleration detection section configured to detect an acceleration of the fishing line released from the spool in the casting operation of the rig, and
a line release speed detection section configured to detect a speed of the fishing line released from the spool in the casting operation of the rig.

12. The water landing location estimation system according to claim 6, wherein
the fishing tackle includes a fishing rod and a fishing reel that is attached to the fishing rod and is provided with a spool around which fishing line is capable of being wound;
the detection unit includes a plurality of detectors selected from a rod detection unit provided on the fishing rod and configured to detect an operating status of the fishing rod in the casting operation of the rig, a reel detection unit provided on the fishing reel and configured to detect an operating status of the fishing reel in the casting operation of the rig, and a spool detection unit provided on the fishing reel and configured to detect an operation of the spool in the casting operation of the rig, and
the calculation unit is configured to estimate the water landing location of the rig that has been cast based on detection results of the plurality of detectors.

13. The water landing location estimation system according to claim 6, further comprising
a display unit configured to display a prediction of the water landing location of the rig estimated by the calculation unit.

14. A fishing assistance system, comprising:
a detection unit configured to detect an operating state of a fishing tackle in a casting operation;
a calculation unit configured to estimate a water landing location of a rig that has been cast based on a detection result of the detection unit;
an underwater detection unit configured to detect an underwater target object; and
a control unit configured to control the underwater detection unit based on the estimation of the calculation unit.

15. The fishing assistance system according to claim 14, wherein
the control unit is configured to control a detection direction of the underwater detection unit based on the estimation of the calculation unit.

16. The fishing assistance system according to claim 14, wherein
the control unit is configured to control a detection distance of the underwater detection unit based on the estimation of the calculation unit.

17. The fishing assistance system according to claim 14, wherein
the detection unit is provided on at least one of a fishing rod, a fishing reel attached to the fishing rod, a fishing line wound around the fishing reel or released from the fishing reel, and the rig attached to the fishing line.

18. The fishing assistance system according to claim 14, wherein
the detection unit is one of a plurality of the detectors is provided on any of a fishing rod, a fishing reel attached to the fishing rod, a fishing line wound around the fishing reel or released from the fishing reel, and the rig attached to the fishing line, each detection unit of the plurality of detectors configured to provide detection results and
the calculation unit is configured to estimate the water landing location of the rig that has been cast based on detection results of the plurality of detectors.

19. The fishing assistance system according to claim 14, wherein
the detection unit includes a plurality of detection unit selected from
a rod detection unit provided on the fishing rod and configured to detect an operating status of the fishing rod in the casting operation of the rig,
a reel detection unit provided on the fishing reel and configured to detect an operating status of the fishing reel in the casting operation of the rig, and
a spool detection unit provided on the fishing reel and configured to detect an operation of the spool in the casting operation of the rig, and
the calculation unit configured to estimate the water landing location of the rig that has been cast based one detection results of the plurality of detectors.

20. The fishing assistance system according to claim 14, further comprising
a display unit configured to display a prediction of the water landing location of the rig estimated by the calculation unit.
